(19) United States
(12) Patent Application Publication
(10) Pub. No.: US 2023/0168333 A1
(43) Pub. Date: Jun. 1, 2023

(54) FLOOR CHANGE DETECTION USING SIGNAL STRENGTH CHANGES AND POSITION ESTIMATION

(71) Applicant: HERE Global B.V., Eindhoven (NL)

(72) Inventors: Luomi Marko, Lempaeaelae (FI); Henri Jaakko Julius Nurminen, Tampere (FI); Pavel Ivanov, Tampere (FI); Lauri Aarne Johannes Wirola, Tampere (FI)

(21) Appl. No.: 17/456,686

(22) Filed: Nov. 29, 2021

(51) Int. Cl. G01S 5/00; G05D 1/02; G01S 5/02

(52) U.S. Cl. CPC G01S 5/016; G05D 1/0219; G05D 1/0257; G01S 5/0269; G05D 2201/0207

(57) ABSTRACT

One or more processors obtain (a) first radio data and a first horizontal position corresponding to a mobile apparatus at a first time and (b) second radio data and a second horizontal position corresponding to the mobile apparatus at a second time. Responsive to determining that the first horizontal position and the second horizontal position are substantially similar, the one or more processors identify differences between the first radio data and the second radio data. Based at least in part on the differences between the first radio data and the second radio data and one or more threshold criteria, the one or more processors determine whether the mobile apparatus changed floors between the first time and the second time.

### TECHNOLOGICAL FIELD

An example embodiment relates generally to positioning. In particular, an example embodiment generally relates to indoor positioning and/or determining when a mobile apparatus has changed floors and/or levels within a building and/or venue comprising multiple floors or levels.

### BACKGROUND

When performing indoor positioning and/or positioning within a building and/or venue comprising multiple floors or levels, it may be desired to be able to determine when an individual (e.g., associated with a mobile apparatus) changes floors and/or levels within the building or venue. Conventionally, floor change detection has been performed based on changes in barometric pressure detected by a mobile apparatus comprising an appropriate atmospheric pressure sensor and/or accelerometer readings.

### BRIEF SUMMARY

Various embodiments provide methods, apparatus, systems, and computer program products for determining whether a mobile apparatus has changed floors and/or levels (e.g., within a building and/or venue). In various embodiments, the mobile apparatus captures first radio data at a first time. The first radio data characterizes radio signals observed by the mobile apparatus at the first time. For example, the first radio data may include radio node identifiers that generated one or more signals observed by the mobile apparatus at the first time, observed signal strengths for the one or more signals observed by the mobile apparatus at the first time, a timing parameter (e.g., one-way time, round-trip-time, timing advance value, and/or the like) for the one or more signals observed by the mobile apparatus at the first time, and/or the like. At a second time, the mobile apparatus captures second radio data that characterizes radio signals observed by the mobile apparatus at the second time.

In various embodiments, when the first horizontal position of the mobile apparatus at the first time is substantially similar to the second horizontal position of the mobile apparatus at the second time, differences in the respective radio environments observed by the mobile apparatus at the first time and at the second time are used to determine whether the mobile apparatus has changed floors and/or levels (e.g., within a building and/or venue) between the first time and the second time. For example, in various embodiments, when the differences in the respective radio environments observed by the mobile apparatus at the first time and at the second time satisfy one or more threshold criteria, it is determined that the mobile apparatus did change floors and/or levels. For example, in various embodiments, when the differences in the respective radio environments observed by the mobile apparatus at the first time and at the second time do not satisfy one or more threshold criteria, it is determined that the mobile apparatus did not change floors and/or levels.

In various embodiments, the determination that the mobile apparatus did or did not change floors and/or levels triggers a respective indicator to be generated and provided (e.g., as input to a positioning algorithm, possibly as confirmation and/or a double check of a result determined a floor change determination algorithm that uses barometric pressure and/or acceleration data; to the mobile apparatus; as input to an application, program, or module that preforms one or more positioning and/or navigation-related functions based on the indicator; a radio map of the building and/or venue may be updated (e.g., to indicate the floor and/or level that a particular radio node is likely located on); and/or the like).

In an example embodiment, one or more processors obtain first radio data comprising one or more first radio node identifiers. Each first radio node identifier is associated with a respective first observed signal strength characterizing an observation made by a radio sensor of a mobile apparatus at the first time of a respective first radio node identified by a respective one of the first radio node identifiers. The one or more processors obtain a first position estimate for the mobile apparatus. The first position estimate corresponds to a first horizontal position of a first location where the mobile apparatus was located at the first time. The one or more processors obtain second radio data comprising one or more second radio node identifiers. Each second radio node identifier is associated with a respective second observed signal strength characterizing an observation made by the radio sensor of the mobile apparatus at a second time of a respective second radio node identified by a respective one of the second radio node identifiers. The one or more processors obtain a second position estimate for the mobile apparatus. The second position estimate corresponds to a second horizontal position of a second location where the mobile apparatus was located at the second time. Responsive to determining that the first horizontal position and the second horizontal position are substantially similar, the one or more processors identify differences between the first radio data and the second radio data. Based at least in part on the differences between the first radio data and the second radio data and one or more threshold criteria, the one or more processors determine whether the first location and the second location are located on different floors.

According to a first aspect of the present disclosure, a method for determining whether a mobile apparatus changed floors and/or levels within a building and/or venue between a first time and a second time. In an example embodiment, the method comprises obtaining, by one or more processors, first radio data comprising one or more first radio node identifiers. Each first radio node identifier is associated with a respective first observed signal strength characterizing an observation made by a radio sensor of a mobile apparatus at the first time of a respective first radio node identified by a respective one of the first radio node identifiers. The method further comprises obtaining, by the one or more processors, a first position estimate for the mobile apparatus. The first position estimate corresponds to a first horizontal position of a first location where the mobile apparatus was located at the first time. The method further comprises obtaining, by the one or more processors, second radio data comprising one or more second radio node identifiers. Each second radio node identifier is associated with a respective second observed signal strength characterizing an observation made by the radio sensor of the mobile apparatus at a second time of a respective second radio node identified by a respective one of the second radio node identifiers. The method further comprises obtaining, by the one or more processors, a second position estimate for the mobile apparatus. The second position estimate corresponds to a second horizontal position of a second location where the mobile apparatus was located at the second time. The method further comprises, responsive to determining that the first horizontal position and the second horizontal position are substantially similar, identifying, by the one or more processors, differences between the first radio data and the second radio data; and, based at least in part on the differences between the first radio data and the second radio data and one or more threshold criteria, determining, by the one or more processors, whether the first location and the second location are located on different floors.

In an example embodiment, identifying differences between the first radio data and the second radio data comprises identifying at least one common radio node identifier present in both (a) the one or more first radio node identifiers and (b) the one or more second radio node identifiers; and for the at least one common radio node identifier, determining a signal strength difference between the respective first observed signal strength and the respective second observed signal strength, wherein determining whether the one or more threshold criteria are satisfied is based at least in part on the signal strength difference.

In an example embodiment, it is determined that a threshold criteria of the one or more threshold criteria is satisfied when the signal strength difference is greater than a threshold difference.

In an example embodiment, the threshold difference is determined based on at least one of (a) an observed noise level or (b) an expected noise level.

In an example embodiment, identifying differences between the first radio data and the second radio data comprises determining at least one of a first number of identifiers that are present in the one or more first radio node identifiers that are not present in the one or more second radio node identifiers, or a second number of identifiers that are present in the one or more second radio node identifiers that are not present in the one or more first radio node identifiers; and determining whether the one or more threshold criteria are satisfied based at least in part on the first number or the second number.

In an example embodiment, it is determined that a threshold criteria of the one or more threshold criteria is satisfied when at least one of (a) the first number or the second number is greater than a threshold number or (b) the first number is a greater percentage of a number of radio identifiers in the one or more first radio node identifiers than a threshold percentage or the second number is a greater percentage of a number of radio node identifiers in the one or more second radio node identifiers.

In an example embodiment, the first position estimate is determined based at least in part on a map-included subset of the first radio data and the second position estimate is determined based at least in part on a map-included subset of the second radio data, wherein the respective map-included subsets of the first radio data and the second radio data correspond to radio nodes for which positioning-enabled information is provided by a radio map accessible to the one or more processors.

In an example embodiment, determining whether the one or more threshold criteria are satisfied comprises determining differences between a not-map-included subset of the first radio data and a not-map-included subset of the second radio data, wherein the respective not-map-included subsets of the first radio data and the second radio data correspond to radio nodes for which positioning-enabled information is not provided by the radio map.

In an example embodiment, the method further comprises at least one of when it is determined that the first location and the second location are located on different floors, providing an indication that the mobile apparatus changed floors; or when it is determined that the first location and the second location are not located on different floors, providing an indication that the mobile apparatus did not change floors.

In an example embodiment, the method further comprises at least one of using the determination of whether the first location and the second location are located on different floors to either confirm or not confirm a floor change determination determined based on at least one of environmental sensor data or motion sensor data captured by respective sensors of the mobile apparatus; or tracking the floor one which the mobile apparatus is located based at least in part on the determination of whether the first location and the second location are located on different floors.

According to another aspect of the present disclosure, an apparatus is provided. In an example embodiment, the apparatus comprises at least one processor and at least one memory storing computer program code. The at least one memory and the computer program code are configured to, with the processor, cause the apparatus to at least obtain first radio data comprising one or more first radio node identifiers, each first radio node identifier associated with a respective first observed signal strength characterizing an observation made by a radio sensor of a mobile apparatus at the first time of a respective first radio node identified by a respective one of the first radio node identifiers; obtain a first position estimate for the mobile apparatus, the first position estimate corresponding to a first horizontal position of a first location where the mobile apparatus was located at the first time; obtain second radio data comprising one or more second radio node identifiers, each second radio node identifier associated with a respective second observed signal strength characterizing an observation made by the radio sensor of the mobile apparatus at a second time of a respective second radio node identified by a respective one of the second radio node identifiers; obtain a second position estimate for the mobile apparatus, the second position estimate corresponding to a second horizontal position of a second location where the mobile apparatus was located at the second time; determine that (i) the first horizontal position and the second horizontal position are substantially similar and (ii) there are one or more differences between the first radio data and the second radio data that satisfy one or more threshold criteria; and based at least in part on the determination that (i) the first horizontal position and the second horizontal position are substantially similar and (ii) there are one or more differences between the first radio data and the second radio data that satisfy one or more threshold criteria, determine that the first location and the second location are located on different floors.

In an example embodiment, identifying differences between the first radio data and the second radio data comprises identifying at least one common radio node identifier present in both (a) the one or more first radio node identifiers and (b) the one or more second radio node identifiers; and for the at least one common radio node identifier, determining a signal strength difference between the respective first observed signal strength and the respective second observed signal strength, wherein determining whether the one or more threshold criteria are satisfied is based at least in part on the signal strength difference.

In an example embodiment, it is determined that a threshold criteria of the one or more threshold criteria is satisfied when the signal strength difference is greater than a threshold difference.

In an example embodiment, the threshold difference is determined based on at least one of (a) an observed noise level or (b) an expected noise level.

In an example embodiment, identifying differences between the first radio data and the second radio data comprises determining at least one of a first number of identifiers that are present in the one or more first radio node identifiers that are not present in the one or more second radio node identifiers, or a second number of identifiers that are present in the one or more second radio node identifiers that are not present in the one or more first radio node identifiers; and determining whether the one or more threshold criteria are satisfied based at least in part on the first number or the second number.

In an example embodiment, it is determined that a threshold criteria of the one or more threshold criteria is satisfied when at least one of (a) the first number or the second number is greater than a threshold number or (b) the first number is a greater percentage of a number of radio identifiers in the one or more first radio node identifiers than a threshold percentage or the second number is a greater percentage of a number of radio node identifiers in the one or more second radio node identifiers.

In an example embodiment, the first position estimate is determined based at least in part on a map-included subset of the first radio data and the second position estimate is determined based at least in part on a map-included subset of the second radio data, wherein the respective map-included subsets of the first radio data and the second radio data correspond to radio nodes for which positioning-enabled information is provided by a radio map accessible to the one or more processors.

In an example embodiment, determining whether the one or more threshold criteria are satisfied comprises determining differences between a not-map-included subset of the first radio data and a not-map-included subset of the second radio data, wherein the respective not-map-included subsets of the first radio data and the second radio data correspond to radio nodes for which positioning-enabled information is not provided by the radio map.

In an example embodiment, the at least one memory and the computer program code are further configured to, with the processor, cause the apparatus to perform at least one of when it is determined that the first location and the second location are located on different floors, providing an indication that the mobile apparatus changed floors; or when it is determined that the first location and the second location are not located on different floors, providing an indication that the mobile apparatus did not change floors.

In an example embodiment, the at least one memory and the computer program code are further configured to, with the processor, cause the apparatus to perform at least one of using the determination of whether the first location and the second location are located on different floors to either confirm or not confirm a floor change determination determined based on at least one of environmental sensor data or motion sensor data captured by respective sensors of the mobile apparatus; or tracking the floor one which the mobile apparatus is located based at least in part on the determination of whether the first location and the second location are located on different floors.

In still another aspect of the present disclosure, a computer program product is provided. In an example embodiment, the computer program product comprises at least one non-transitory computer-readable storage medium having computer-readable program code portions stored therein. The computer-readable program code portions comprise executable portions configured, when executed by a processor of an apparatus, to cause the apparatus to obtain first radio data comprising one or more first radio node identifiers, each first radio node identifier associated with a respective first observed signal strength characterizing an observation made by a radio sensor of a mobile apparatus at the first time of a respective first radio node identified by a respective one of the first radio node identifiers; obtain a first position estimate for the mobile apparatus, the first position estimate corresponding to a first horizontal position of a first location where the mobile apparatus was located at the first time; obtain second radio data comprising one or more second radio node identifiers, each second radio node identifier associated with a respective second observed signal strength characterizing an observation made by the radio sensor of the mobile apparatus at a second time of a respective second radio node identified by a respective one of the second radio node identifiers; obtain a second position estimate for the mobile apparatus, the second position estimate corresponding to a second horizontal position of a second location where the mobile apparatus was located at the second time; determine that (i) the first horizontal position and the second horizontal position are substantially similar and (ii) there are one or more differences between the first radio data and the second radio data that satisfy one or more threshold criteria; and based at least in part on the determination that (i) the first horizontal position and the second horizontal position are substantially similar and (ii) there are one or more differences between the first radio data and the second radio data that satisfy one or more threshold criteria, determine that the first location and the second location are located on different floors.

In an example embodiment, identifying differences between the first radio data and the second radio data comprises identifying at least one common radio node identifier present in both (a) the one or more first radio node identifiers and (b) the one or more second radio node identifiers; and for the at least one common radio node identifier, determining a signal strength difference between the respective first observed signal strength and the respective second observed signal strength, wherein determining whether the one or more threshold criteria are satisfied is based at least in part on the signal strength difference.

In an example embodiment, it is determined that a threshold criteria of the one or more threshold criteria is satisfied when the signal strength difference is greater than a threshold difference.

In an example embodiment, the threshold difference is determined based on at least one of (a) an observed noise level or (b) an expected noise level.

In an example embodiment, identifying differences between the first radio data and the second radio data comprises determining at least one of a first number of identifiers that are present in the one or more first radio node identifiers that are not present in the one or more second radio node identifiers, or a second number of identifiers that are present in the one or more second radio node identifiers that are not present in the one or more first radio node identifiers; and determining whether the one or more threshold criteria are satisfied based at least in part on the first number or the second number.

In an example embodiment, it is determined that a threshold criteria of the one or more threshold criteria is satisfied when at least one of (a) the first number or the second number is greater than a threshold number or (b) the first number is a greater percentage of a number of radio identifiers in the one or more first radio node identifiers than a threshold percentage or the second number is a greater percentage of a number of radio node identifiers in the one or more second radio node identifiers.

In an example embodiment, the first position estimate is determined based at least in part on a map-included subset of the first radio data and the second position estimate is determined based at least in part on a map-included subset of the second radio data, wherein the respective map-included subsets of the first radio data and the second radio data correspond to radio nodes for which positioning-enabled information is provided by a radio map accessible to the one or more processors.

In an example embodiment, determining whether the one or more threshold criteria are satisfied comprises determining differences between a not-map-included subset of the first radio data and a not-map-included subset of the second radio data, wherein the respective not-map-included subsets of the first radio data and the second radio data correspond to radio nodes for which positioning-enabled information is not provided by the radio map.

In an example embodiment, the computer-readable program code portions comprise executable portions further configured, when executed by a processor of an apparatus, to cause the apparatus to perform at least one of when it is determined that the first location and the second location are located on different floors, providing an indication that the mobile apparatus changed floors; or when it is determined that the first location and the second location are not located on different floors, providing an indication that the mobile apparatus did not change floors.

In an example embodiment, the computer-readable program code portions comprise executable portions further configured, when executed by a processor of an apparatus, to cause the apparatus to perform at least one of using the determination of whether the first location and the second location are located on different floors to either confirm or not confirm a floor change determination determined based on at least one of environmental sensor data or motion sensor data captured by respective sensors of the mobile apparatus; or tracking the floor one which the mobile apparatus is located based at least in part on the determination of whether the first location and the second location are located on different floors.

According to yet another aspect of the present disclosure, an apparatus is provided. In an example embodiment, the apparatus comprises means for obtaining first radio data comprising one or more first radio node identifiers. Each first radio node identifier is associated with a respective first observed signal strength characterizing an observation made by a radio sensor of a mobile apparatus at the first time of a respective first radio node identified by a respective one of the first radio node identifiers. The apparatus comprises means for obtaining a first position estimate for the mobile apparatus. The first position estimate corresponds to a first horizontal position of a first location where the mobile apparatus was located at the first time. The apparatus comprises obtaining second radio data comprising one or more second radio node identifiers. Each second radio node identifier is associated with a respective second observed signal strength characterizing an observation made by the radio sensor of the mobile apparatus at a second time of a respective second radio node identified by a respective one of the second radio node identifiers. The apparatus comprises means for obtaining a second position estimate for the mobile apparatus. The second position estimate corresponds to a second horizontal position of a second location where the mobile apparatus was located at the second time. The apparatus comprises means for identifying differences between the first radio data and the second radio data responsive to determining that the first horizontal position and the second horizontal position are substantially similar. The apparatus comprises means for determining whether the first location and the second location are located on different floors based at least in part on the differences between the first radio data and the second radio data and one or more threshold criteria.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example system of one embodiment of the present disclosure;

FIG. 2A is a block diagram of a network apparatus that may be specifically configured in accordance with an example embodiment;

FIG. 2B is a block diagram of a mobile apparatus that may be specifically configured in accordance with an example embodiment;

FIG. 3 is a schematic diagram illustrating the location of radio nodes and the mobile apparatus within a building at a first time and a second time, the first and second radio data, and corresponding map data of a radio map of the building, in accordance with an example embodiment;

FIG. 4 is a flowchart illustrating operations performed, such as by the mobile apparatus of FIG. 2B, to capture the first and second radio data and to perform some possible subsequent actions, in accordance with an example embodiment;

FIG. 5 is a flowchart illustrating operations performed, such as by the network apparatus of FIG. 2A and/or the mobile apparatus of FIG. 2B, to determine whether the mobile apparatus changed floors and/or levels, in accordance with an example embodiment;

FIG. 6 is a flowchart illustrating operations performed, such as by the network apparatus of FIG. 2A and/or the mobile apparatus of FIG. 2B, to determine whether the differences between the first radio data and the second radio data satisfy the one or more threshold criteria, in accordance with an example embodiment; and

FIG. 7 is a flowchart illustrating operations performed, such as by the network apparatus of FIG. 2A and/or the mobile apparatus of FIG. 2B, to determine whether the differences between the first radio data and the second radio data satisfy the one or more threshold criteria, in accordance with an example embodiment.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. As used herein, the terms “substantially” and “approximately” refer to values and/or tolerances that are within manufacturing and/or engineering guidelines and/or limits. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

### I. General Overview

Various embodiments provide methods, apparatus, systems, and computer program products for determining whether a mobile apparatus has changed floors and/or levels (e.g., within a building and/or venue). In various embodiments, the mobile apparatus captures first radio data at a first time. The first radio data characterizes radio signals observed by the mobile apparatus at the first time. For example, the first radio data may include radio node identifiers that generated one or more signals observed by the mobile apparatus at the first time, observed signal strengths for the one or more signals observed by the mobile apparatus at the first time, a timing parameter (e.g., one-way time, round-trip-time, timing advance value, and/or the like) for the one or more signals observed by the mobile apparatus at the first time, and/or the like. At a second time, the mobile apparatus captures second radio data that characterizes radio signals observed by the mobile apparatus at the second time.

In various embodiments, when the first horizontal position of the mobile apparatus at the first time is substantially similar to the second horizontal position of the mobile apparatus at the second time, differences in the respective radio environments observed by the mobile apparatus at the first time and at the second time are used to determine whether the mobile apparatus has changed floors and/or levels (e.g., within a building and/or venue) between the first time and the second time. For example, in various embodiments, when the differences in the respective radio environments observed by the mobile apparatus at the first time and at the second time satisfy one or more threshold criteria, it is determined that the mobile apparatus did change floors and/or levels. For example, in various embodiments, when the differences in the respective radio environments observed by the mobile apparatus at the first time and at the second time do not satisfy one or more threshold criteria, it is determined that the mobile apparatus did not change floors and/or levels.

In various embodiments, the determination that the mobile apparatus did or did not change floors and/or levels triggers a respective indicator to be generated and provided (e.g., as input to a positioning algorithm, possibly as confirmation and/or a double check of a result determined a floor change determination algorithm that uses barometric pressure and/or acceleration data; to the mobile apparatus; as input to an application, program, or module that preforms one or more positioning and/or navigation-related functions based on the indicator; a radio map of the building and/or venue may be updated (e.g., to indicate the floor and/or level that a particular radio node is likely located on); and/or the like).

Conventionally, determining whether a mobile apparatus has changed floor and/or levels within a building and/or venue is performed based on barometric pressure data and/or acceleration data captured by mobile apparatus. However, in various scenarios (e.g., a change in the weather, a change in the operation of the building and/or venue air handlers, and/or the like) the barometric pressure may change quickly independent of whether or not the mobile apparatus changes floors. Moreover, not all mobile apparatus are equipped with an appropriate sensor for capturing barometric pressure data. There are also instances where acceleration data may indicate false positives or false negatives for a floor change. Therefore, a technical problem exists regarding how to determine when a mobile apparatus has changed floors within a building and/or venue.

Various embodiments provide technical solutions to these technical problems. In particular, first radio data characterizing the radio environment observed by the mobile apparatus at a first time is captured and second radio data characterizing the radio environment observed by the mobile apparatus at a second time is captured. When the horizontal position of the mobile apparatus is substantially the same at the first time and the second time (e.g., the first and second horizontal positions are within a threshold distance of one another such that the radio environment is expected to not substantively change, the mobile apparatus is located within the same building and/or venue, and/or the like), it may be determined whether the first radio data and the second radio data are substantively similar or not (e.g., based on whether the differences between the first radio data and the second radio data satisfy one or more threshold criteria).

Various embodiments, therefore, provide a technique for determining whether a mobile apparatus has changed floor and/or levels within a building and/or venue that is independent of barometric pressure data and/or accelerometer data. Thus, the change in radio environment determination of whether a mobile apparatus has changed floors and/or levels within a building and/or venue disclosed herein may be used independently (e.g., in situations where barometric data and/or accelerometer data are not available and/or reliable) and/or to confirm a floor change determination that was determined based on barometric pressure data and/or accelerometer data, for example.

As these floor change determinations may be used to perform one or more positioning and/or navigation-related functions corresponding to the mobile apparatus (e.g., tracking the mobile apparatus's location within the building and/or venue, determining the location of the mobile apparatus within the building and/or venue, determining a route that is at least partially within the building and/or venue, providing route guidance for a route that is at least partially within the building and/or venue, updating a radio map corresponding to at least a portion of the building and/or venue, and/or the like), various embodiments provide improvements to the technical field of indoor positioning and/or navigation.

### II. Example System Architecture

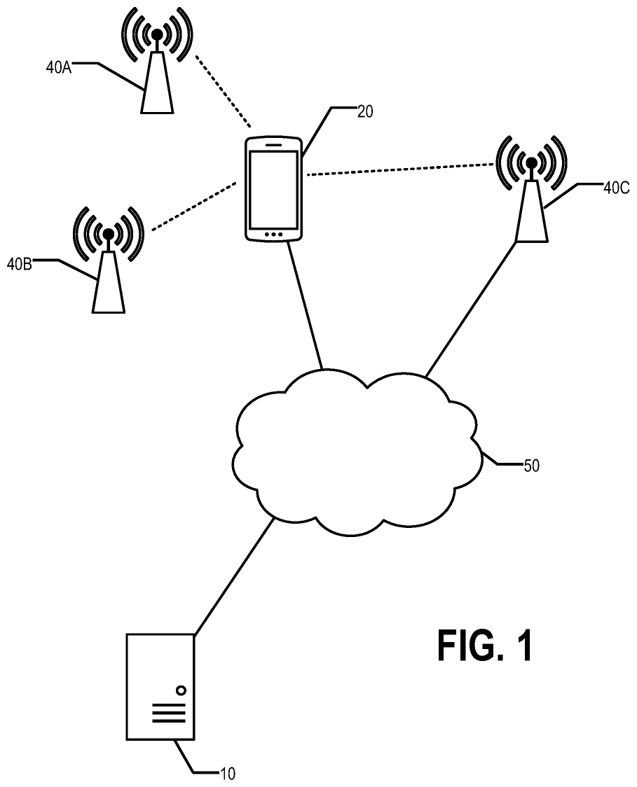

FIG. 1 provides an illustration of an example system that can be used in conjunction with various embodiments of the present invention. As shown in FIG. 1, the system may include one or more network apparatus 10, one or more mobile apparatus 20, one or more radio nodes 40 (e.g., 40A, 40B, 40C), one or more networks 50, and/or the like. In various embodiments, the mobile apparatus 20 may be a mobile computing device, a mobile data gathering platform, IoT device, and/or the like. In various embodiments, the mobile apparatus 20 may be a smartphone, tablet, personal digital assistant (PDA), navigation device, personal computer, client device, laptop, mobile computing device, IoT device, and/or the like. In general, an IoT device is a mechanical and/or digital device configured to communicate with one or more computing devices and/or other IoT devices via one or more wired and/or wireless networks 50. In an example embodiment, the network apparatus 10 is a server, group of servers, distributed computing system, Cloud-based computing resource, and/or other computing system. For example, the network apparatus 10 may be in communication with one or more mobile apparatuses 20 and/or the like via one or more wired or wireless networks 50. In various embodiments, the radio nodes 40 may be wireless network access points; Wi-Fi devices, network access points, and/or beacons; Bluetooth devices, network access points, and/or beacons; cellular network access points; and/or disposed within the building and/or venue and configured to emit, transmit, generate, and/or broadcast radio frequency signals.

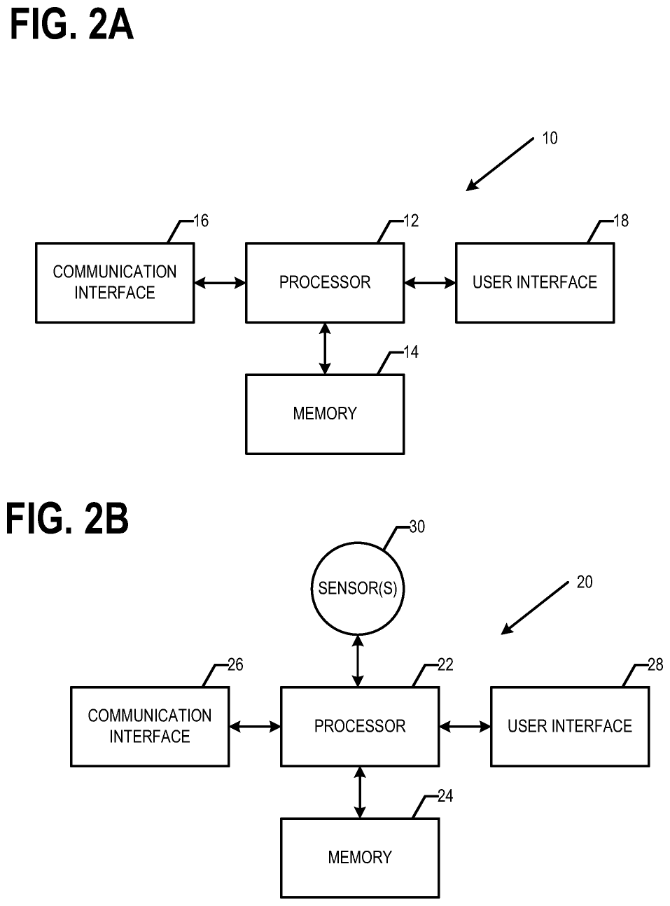

In an example embodiment, a network apparatus 10 may comprise components similar to those shown in the example network apparatus 10 diagrammed in FIG. 2A. In an example embodiment, the network apparatus 10 is configured to obtain first radio data captured and/or generate by the mobile apparatus 20 at a first time, obtain a first position estimate including a first horizontal position of the mobile apparatus at the first time, obtain second radio data captured and/or generated by the mobile apparatus 20 at a second time, obtain a second position estimate including a second horizontal position of the mobile apparatus 20 at the second time, determine if the first horizontal position and the second horizontal position are substantially similar to one another, determine whether differences between the first radio data and the second radio data satisfy one or more threshold criteria, generate and provide an indication of whether the mobile apparatus changed floors and/or levels between the first time and the second time, perform one or more positioning and/or navigation-related functions based at least in part on whether the mobile apparatus changed floors and/or levels within the building and/or venue between the first time and the second time, update a radio map of the building and/or venue based at least in part on whether the mobile apparatus changed floors and/or levels within the building and/or venue between the first time and the second time, and/or the like. For example, as shown in FIG. 2A, the network apparatus 10 may comprise a processor 12, memory 14, a user interface 18, a communications interface 16, and/or other components configured to perform various operations, procedures, functions or the like described herein. In various embodiments, the network apparatus 10 stores a geographical database and/or positioning map such as a radio map corresponding to at least a portion of a building and/or venue (e.g., in memory 14). In at least some example embodiments, the memory 14 is non-transitory.

In an example embodiment, a mobile apparatus 20 is a mobile computing entity, IoT device, and/or the like. In an example embodiment, the mobile apparatus 20 may be configured to capture, generate, and/or obtain first radio data and second radio data; obtain a first position estimate comprising a first horizontal position; obtain a second position estimate comprising a second horizontal position; determine if the first horizontal position and the second horizontal position are substantially similar to one another; determine whether differences between the first radio data and the second radio data satisfy one or more threshold criteria; generate and provide an indication of whether the mobile apparatus changed floors and/or levels between the first time and the second time; perform one or more positioning and/or navigation-related functions based at least in part on whether the mobile apparatus changed floors and/or levels within the building and/or venue between the first time and the second time; update a radio map of the building and/or venue based at least in part on whether the mobile apparatus changed floors and/or levels within the building and/or venue between the first time and the second time; and/or the like. In an example embodiment, as shown in FIG. 2B, the mobile apparatus 20 may comprise a processor 22, memory 24, a communications interface 26, a user interface 28, one or more sensors 30 and/or other components configured to perform various operations, procedures, functions or the like described herein. In various embodiments, the mobile apparatus 20 stores at least a portion of one or more digital maps (e.g., geographic databases, positioning maps such as a radio map corresponding to at least a portion of a building and/or venue, and/or the like) and/or computer executable instructions for performing one or more positioning-related and/or navigation related functions in memory 24. In at least some example embodiments, the memory 24 is non-transitory.

In various embodiments, the sensors 30 comprise one or more location sensors such as a GNSS sensor, inertial measurement unit (IMU) and/or motion sensors (e.g., accelerometers, gyroscopes, magnetometers, and/or the like), altimeters, and/or the like. In various embodiments, the sensors 30 comprise one or more image sensors configured to capture visual samples, such as digital camera(s), 3D cameras, 360° cameras, and/or image sensors. In various embodiments, the sensors 30 comprise one or more audio sensors configured to capture audio samples, such as a microphone and/or other audio sensor. In an example embodiment, the one or more sensors 30 comprise one or more environmental sensors such barometers, thermometers, humidity sensors, and/or the like. In various embodiments, the one or more sensors 30 may comprise one or more interfaces, such as radio interfaces, configured to observe and/or receive (radio frequency) signals generated and/or transmitted by one or more access points and/or radio nodes 40. For example, the one or more interfaces may be configured (possibly in coordination with processor 22) to determine a radio node identifier configured to identify the radio node 40 that generated and/or transmitted a signal observed by the mobile apparatus 20, a signal strength of the signal observed by the mobile apparatus 20, a one-way or round-trip-time value for a signal observed by the mobile apparatus 20, and/or the like. As used herein, when a mobile apparatus 20 observes radio node 40, the mobile apparatus 20 has observed a (radio frequency) signal emitted, broadcast, generated, and/or transmitted by the radio node 40. In an example embodiment, the interface may be configured to observe one or more types of signals such as generated and/or transmitted in accordance with one or more protocols such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface may be configured to observe radio, millimeter, microwave, and/or infrared wavelength signals. In an example embodiment, the interface may be coupled to and/or part of a communications interface 26. In various embodiments, the sensors 30 may comprise various other sensors such as two dimensional (2D) and/or three dimensional (3D) light detection and ranging (LiDAR)(s), long, medium, and/or short range radio detection and ranging (RADAR), ultrasonic sensors, electromagnetic sensors, (near-) infrared (IR) cameras, and/or the like.

Each of the components of the system may be in electronic communication with, for example, one another over the same or different wireless or wired networks 50 including, for example, a wired or wireless Personal Area Network (PAN), Local Area Network (LAN), Metropolitan Area Network (MAN), Wide Area Network (WAN), cellular network, and/or the like. In an example embodiment, a network 50 comprises the automotive cloud, digital transportation infrastructure (DTI), radio data system (RDS)/high definition (HD) radio or other digital radio system, and/or the like.

For example, a mobile apparatus 20 may be in communication with a network apparatus 10 via the network 50. For example, a mobile apparatus 20 may communicate with the network apparatus 10 via a network, such as the Cloud. For example, the Cloud may be a computer network that provides shared computer processing resources and data to computers and other devices connected thereto. For example, the mobile apparatus 20 may be configured to provide first radio data, second radio data, a first position estimate, and/or a second position estimate via the network 50. For example, a mobile apparatus 20 may be configured to receive an indication of whether the mobile apparatus changed floors and/or levels and/or a result of a positioning and/or navigation-related function determined based at least in part on the determination of whether the mobile apparatus changed levels via the network 50. For example, the network apparatus 10 may configured to receive first radio data, second radio data, a first position estimate, and/or a second position estimate and/or provide an indication of whether the mobile apparatus changed floors and/or levels and/or a result of a positioning and/or navigation-related function determined based at least in part on the determination of whether the mobile apparatus changed levels via the network 50. In various embodiments, one or more radio nodes 40 are wireless access points that enable the mobile apparatus 20 to communicate via the network 50.

Certain example embodiments of the network apparatus 10 and/or mobile apparatus 20 are described in more detail below with respect to FIGS. 2A and 2B.

### III. Example Operation(s)

In various embodiments, a network apparatus 10 and/or mobile apparatus 20 is configured to determine whether the mobile apparatus 20 changed floors and/or levels within a building and/or venue between a first time and a second time. In various embodiments, the determination of whether the mobile apparatus 20 changed floors and/or levels within the building and/or venue is performed in a periodic manner (e.g., every second, every fifteen seconds, every thirty seconds, every minute, every five minutes, every ten minutes, and/or the like). In various embodiments, the determination of whether the mobile apparatus 20 changed floors and/or levels within the building and/or venue is triggered by an application program interface (API) call, for example, generated and/or provided by a hybrid positioning application, program, and/or module (e.g., configured to use motion data in addition to other data to determine a position estimate for the mobile apparatus 20); a routing and/or tracking application, program, and/or module; a radio map updating application, program, and/or module; and/or the like.

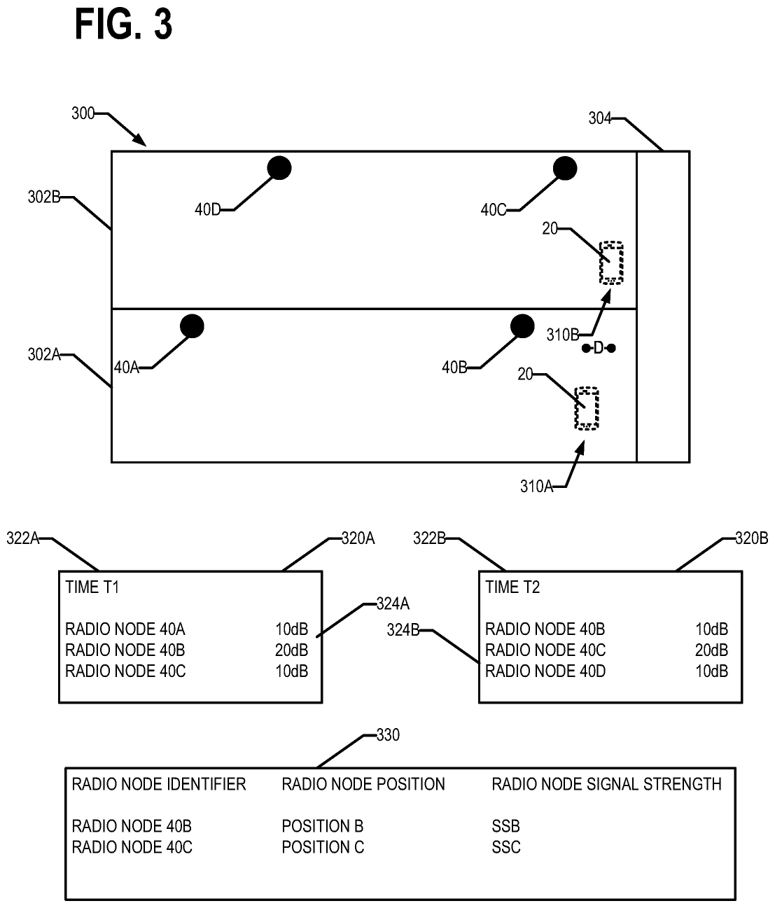

FIG. 3 illustrates an example scenario in which an embodiment may be used to determine whether the mobile apparatus 20 has changed floors and/or levels within a building and/or venue between a first time and a second time. For example, FIG. 3 illustrates a cross-section of at least a portion of a building 300 including a first floor 302A and a second floor 302B. The first floor 302A and second floor 302B are connected with one another by floor-changing infrastructure 304, such as a staircase, elevator, escalator, and/or the like. Radio nodes 40A, 40B, 40C, and 40D are disposed within the building 300, with the first radio node 40A and the second radio node 40B disposed on the first floor 302A and the third radio node 40C and the fourth radio node 40D disposed on the second floor 302B.

At a first time, the mobile apparatus 20 is located at a first location 310A. The first location 310A corresponds to the first floor 302A and a first horizontal position indicating where on the corresponding floor the first location 310A is. At a second time, the mobile apparatus 20 is located at a second location 310B. The second location 310B corresponds to the second floor 302B and a second horizontal position indicating whereon the corresponding floor the second location 310B is. The first horizontal position and the second horizontal position differ by a two-dimensional distance D. For example, the first horizontal position and the second horizontal position correspond to the two-dimensional projection of the first location 310A and the second location 310B, respectively, into a plane that is perpendicular to the vertical axis (e.g., perpendicular to the Earth's surface at the location of the building 300). The distance D is the distance between the two-dimensional projections of the first location 310A and the second location 310B in the plane perpendicular to the vertical axis.

At the first time, the mobile apparatus 20 captures and/or generates first radio data 320A. The first radio data 320A comprises a first timestamp 322A indicating that the first radio data corresponds to the radio environment observed by the mobile apparatus 20 (e.g., a radio sensor and/or radio interface 30 of the mobile apparatus 20) at the first time T1. The first radio data 322A further comprises first observation information 324A. In the illustrated embodiment, the first observation information 324A comprises first radio node identifiers and corresponding signal strength indicators. Each radio node identifier of the first radio node identifiers is configured to identify a respective radio node that was observed by the mobile apparatus 20 at the first time T1. Each radio node identifier of the first radio node identifiers is associated with observation characteristics that characterize the mobile apparatus's 20 observation of the respective radio node (e.g., a signal strength indicator indicating the observed signal strength, a timing parameter (e.g., one-way time, round-trip-time, timing advance value, and/or the like), a frequency (band) or channel, and/or the like).

At the second time, the mobile apparatus 20 captures and/or generates second radio data 320B. The second radio data 320B comprise a second timestamp 322B indicating that the second radio data 320B corresponds to the radio environment observed by the mobile apparatus 20 at the second time T2. The second radio data 322A further comprises second observation information 324B. In the illustrated embodiment, the second observation information 324B comprises second radio node identifiers and corresponding signal strength indicators. Each radio node identifier of the second radio node identifiers is configured to identify a respective radio node that was observed by the mobile apparatus 20 at the second time T2. Each radio node identifier of the second radio node identifiers is associated with observation characteristics that characterize the mobile apparatus's 20 observation of the respective radio node (e.g., a signal strength indicator indicating the observed signal strength, a timing parameter (e.g., one-way time, round-trip-time, timing advance value, and/or the like), a frequency (band) or channel, and/or the like).

FIG. 3 also includes an example representation of a radio map 330 for the building 300. In the illustrated embodiment, the radio map 330 comprises a radio node identifier for one or more radio nodes 40 disposed within the building 300 associated with positioning-enabling information corresponding to the respective radio nodes. For example, the illustrated radio map includes a position of the second radio node 40B in association with a transmission signal strength value for the second radio node 40B and a radio node identifier for the second radio node 40B. In various embodiments, the radio map corresponding to at least a portion of the building may include coverage area maps and/or coverage area defining information, and/or other forms of radio models corresponding to respective radio nodes, where each of the radio models are configured to enable positioning of a mobile apparatus based on the mobile apparatus observing one or more of the respective radio nodes.

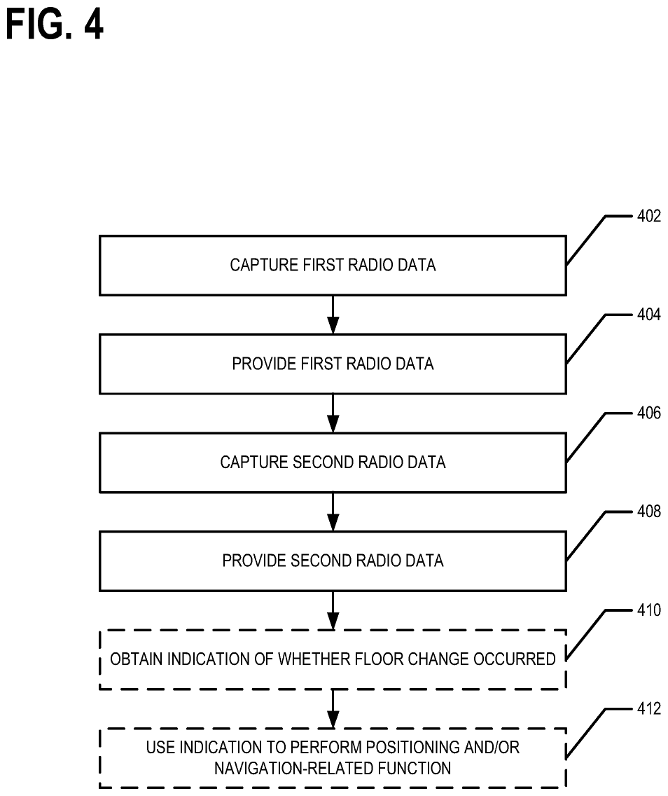

FIG. 4 provides a flowchart illustrating various processes, procedures, operations, and/or the like performed by the mobile apparatus 20 in order to enable the determination of whether the mobile apparatus 20 changed floors and/or levels within the building and/or venue between the first time and the second time and some possible processes, procedures, operations, and/or the like the mobile apparatus 20 may perform as a result of the determination of whether the mobile apparatus 20 changed floors and/or levels.

Starting at block 402, the mobile apparatus 20 captures and/or generates first radio data corresponding to a first time. For example, the mobile apparatus 20 may use radio sensor and/or radio interface 30 to observe the radio environment (e.g., one or more radio signals) about the mobile apparatus 20 at the first time. The mobile apparatus 20 then generates the first radio data based on the observed radio signals. For example, in various embodiments, the first radio data comprises one or more first radio node identifiers that are each configured to identify a radio node 40 observed by the mobile apparatus 20 at the first time T1. In various embodiments, the first radio data comprises respective observation characterizations (e.g., a signal strength indicator indicating the observed signal strength, a timing parameter (e.g., one-way time, round-trip-time, timing advance value, and/or the like), a frequency (band) or channel, and/or the like) in association with the respective radio node identifier of the first radio node identifiers. For example, the mobile apparatus comprises means, such as processor 22, memory 24, sensors 30, and/or the like, for capturing and/or generating the first radio data. For example, the memory 24 may store computer program code and/or executable instructions that, when executed by the processor 22, provide a radio environment monitoring application, program, and/or module and/or a radio sensor/interface 30 controller configured to cause the capturing and/or generating of the first radio data corresponding to the first time.

At block 404, the mobile apparatus 20 provides the first radio data. For example, the mobile apparatus 20 provides (e.g., transmits) the first radio data such that the network apparatus 10 receives the first radio data (e.g., via network 50), in various embodiments. In another example, the mobile apparatus 20 provides the first radio data to positioning application, program, and/or module; a floor change determination application, program, and/or module; and/or other application, program, and/or module operating and/or being executed by the mobile apparatus 20. In an example embodiment, the mobile apparatus 20 provides the first radio data to memory (e.g., memory 24) for future use. For example, the mobile apparatus 20 comprises means, such as processor 22, memory 24, communication interface 26, and/or the like, for providing the first radio data. For example, the memory 24 may store computer program code and/or executable instructions that, when executed by the processor 22, provide a radio environment monitoring application, program, and/or module and/or a radio sensor/interface 30 controller configured to cause the first radio data to be provided.

Starting at block 406, the mobile apparatus 20 captures and/or generates second radio data corresponding to a second time. For example, the mobile apparatus 20 may use radio sensor and/or radio interface 30 to observe the radio environment (e.g., one or more radio signals) about the mobile apparatus 20 at the second time. The mobile apparatus 20 then generates the second radio data based on the observed radio signals. For example, in various embodiments, the second radio data comprises one or more second radio node identifiers that are each configured to identify a radio node 40 observed by the mobile apparatus 20 at the second time T2. In various embodiments, the second radio data comprises respective observation characterizations (e.g., a signal strength indicator indicating the observed signal strength, a timing parameter (e.g., one-way time, round-trip-time, timing advance value, and/or the like), a frequency (band) or channel, and/or the like) in association with the respective radio node identifier of the second radio node identifiers. For example, the mobile apparatus comprises means, such as processor 22, memory 24, sensors 30, and/or the like, for capturing and/or generating the second radio data. For example, the memory 24 may store computer program code and/or executable instructions that, when executed by the processor 22, provide a radio environment monitoring application, program, and/or module and/or a radio sensor/interface 30 controller configured to cause the capturing and/or generating of the second radio data corresponding to the second time.

In various embodiments, the second time may be a particular amount of time and/or a configurable amount of time after the first time. For example, the second time may be one second, five seconds, ten seconds, fifteen seconds, thirty seconds, one minute, two minutes, five minutes, and/or ten minutes after the first time. In general, the first time and the second time are generally configured such that the mobile apparatus is likely to be located within the same building and/or venue at the first time and the second time. For example, the first time and the second time are not separated by hours, days, weeks, and/or the like, in various embodiments.

At block 408, the mobile apparatus 20 provides the second radio data. For example, the mobile apparatus 20 provides (e.g., transmits) the second radio data such that the network apparatus 10 receives the second radio data (e.g., via network 50), in various embodiments. In another example, the mobile apparatus 20 provides the second radio data to positioning application, program, and/or module; a floor change determination application, program, and/or module; and/or other application, program, and/or module operating and/or being executed by the mobile apparatus 20. In an example embodiment, the mobile apparatus 20 provides the second radio data to memory (e.g., memory 24) for future use. For example, the mobile apparatus 20 comprises means, such as processor 22, memory 24, communication interface 26, and/or the like, for providing the second radio data. For example, the memory 24 may store computer program code and/or executable instructions that, when executed by the processor 22, provide a radio environment monitoring application, program, and/or module and/or a radio sensor/interface 30 controller configured to cause the second radio data to be provided.

At block 410, the mobile apparatus 20 obtains an indication of whether the mobile apparatus 20 changed floors and/or levels between the first time and the second time. For example, the mobile apparatus 20 may receive an indication that the mobile apparatus did change floors and/or levels responsive to a determination (e.g., by the network apparatus 10 and/or the mobile apparatus 20) that the mobile apparatus 20 changed floors and/or levels between the first time and the second time, in an example embodiment. For example, the mobile apparatus 20 may receive an indication that the mobile apparatus did not change floors and/or levels responsive to a determination (e.g., by the network apparatus 10 and/or the mobile apparatus 20) that the mobile apparatus 20 did not change floors and/or levels between the first time and the second time, in an example embodiment. For example, the indication of whether the mobile apparatus changed floors and/or levels may be received as an API call, an API response (e.g., in response to an API call requesting a floor change determination be made), as a push notification, and/or the like. In an example embodiment, the network apparatus 10 generates and provides (e.g., transmits) the indication such that the mobile apparatus 20 receives the indication (e.g., via network 50). In an example embodiment, the mobile apparatus 20 generates and provides the indication. In an example embodiment, the mobile apparatus 20 provides (e.g., transmits) the indication such that the network apparatus 10 receives the indication. For example, the mobile apparatus 20 comprises means, such as processor 22, memory 24, communications interface 26, and/or the like, for obtaining an indication of whether the mobile apparatus 20 changed floors and/or levels within the building and/or venue between the first time and the second time.

At block 412, the mobile apparatus 20 uses the indication of whether the mobile apparatus 20 changed floors and/or levels within the building and/or venue between the first time and the second time to perform one or more positioning and/or navigation-related functions. In various embodiments, the one or more positioning and/or navigation-related functions comprise one or more of determining a position estimate for the mobile apparatus 20, displaying a position estimate via a user interface 28, route determination, route guidance, radio environment learning (e.g., radio map updating), confirming a floor change detection determined and/or identified based on motion and/or environmental sensor data (e.g., barometric pressure data and/or acceleration data), and/or the like. For example, the mobile apparatus 20 comprises means, such as processor 22, memory 24, communication interface 26, user interface 28, and/or the like, for performing one or more positioning and/or navigation-related functions based at least in part on the indication of whether mobile apparatus 20 changed floors and/or levels within the building and/or venue between the first time and the second time. For example, a route within the building and/or venue may be displayed as an overlay of floor map of the building and/or venue via user interface 28. Responsive to the indication that the mobile apparatus has changed floors and/or levels, the floor map corresponding to the floor and/or level of the building that the mobile apparatus 20 is currently located on that is displayed via user interface 28 may be updated accordingly.

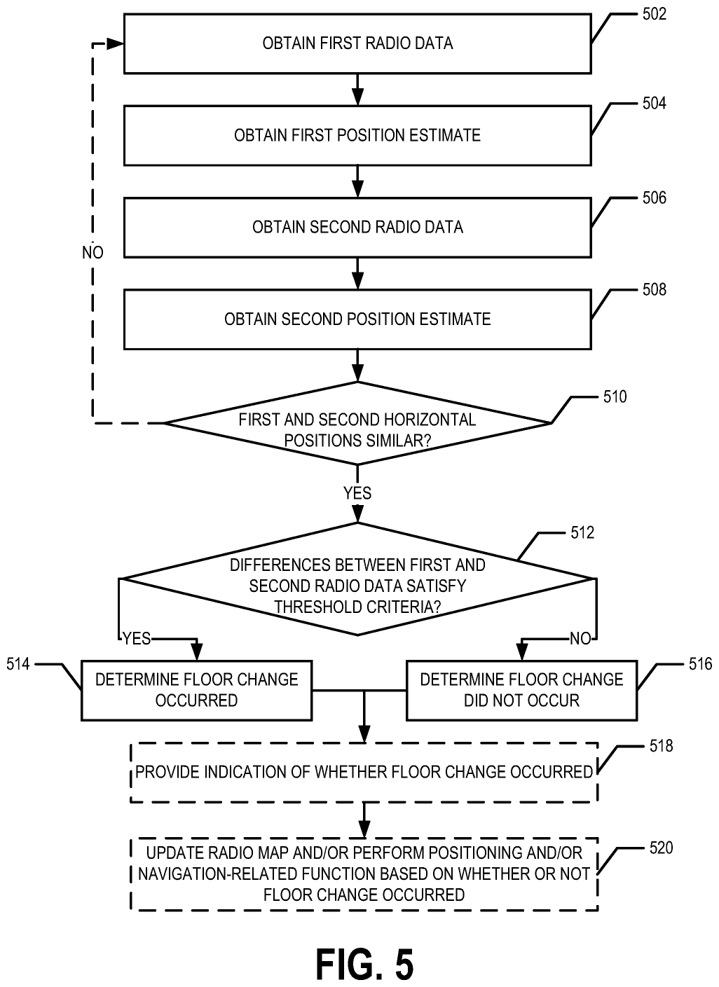

In various embodiments, the network apparatus 10 and/or the mobile apparatus 20 determines whether the mobile apparatus 20 changed floors and/or levels within the building and/or venue between the first time and the second time. FIG. 5 provides a flowchart illustrating various processes, procedures, operations, and/or the like for determining whether the mobile apparatus 20 changed floors and/or levels within the building and/or venue between the first time and the second time and some possible actions that may be taken based thereon.

Starting at block 502, first radio data is obtained. For example, the network apparatus 10 and/or mobile apparatus 20 obtains first radio data. For example, the network apparatus 10 and/or mobile apparatus 20 comprises means, such as processor 12, 22, memory 14, 24, communications interface 16, 26, and/or the like. For example, the network apparatus 10 may receive the first radio data (e.g., via network 50 and/or communications interface 16).

In various embodiments, the first radio data comprises a first timestamp indicating that the first radio data corresponds to the radio environment observed by the mobile apparatus 20 (e.g., a radio sensor and/or radio interface 30 of the mobile apparatus 20) at the first time T1. The first radio data further comprises first observation information. In various embodiments, the first observation information comprises first radio node identifiers, each configured to identify a respective radio node observed by the mobile apparatus 20 at the first time. The first observation information further comprises respective observation characteristics that characterize the mobile apparatus's observation of each respective radio node identified by a respective first radio node identifier. In various embodiments, the observation characteristics that characterize the mobile apparatus's 20 observation of respective radio node include one or more of a signal strength indicator indicating the observed signal strength, a timing parameter (e.g., one-way time, round-trip-time, timing advance value, and/or the like), a frequency (band) or channel, and/or the like.

At block 504, a first position estimate is obtained. For example, the network apparatus 10 and/or mobile apparatus 20 obtains a first position estimate. In various embodiments, the first position estimate corresponds to a first location where the mobile apparatus 20 was located at the first time. In various embodiments, the first position estimate comprises a first horizontal position. The first horizontal position indicates the location of a two-dimensional projection of the first position estimate in a plane that is perpendicular to the vertical direction. For example, the first horizontal position may be a latitude and longitude estimating the first location. In another embodiment, the first horizontal position may be a two-dimensional position estimate in local and/or relative coordinates. For example, the network apparatus 10 and/or the mobile apparatus 20 comprises means, such as processor 12, 22, memory 14, 24, communications interface 16, 26, user interface 28, and/or the like, for obtaining the first position estimate.

In an example embodiment, the first position estimate is received (by the network apparatus 10 and/or mobile apparatus 20) via communications interface 16, 26. For example, the first position estimate may be determined and/or generated by a Cloud-based positioning service, and/or other positioning system which then provides the first position estimate such that the network apparatus 10 and/or the mobile apparatus 20 receives the first position estimate. In an example embodiment, the first position estimate is stored in memory 14, 24 and the network apparatus 10 and/or mobile apparatus 20 obtains the first position estimate by accessing the first position estimate from memory. In an example embodiment, the network apparatus 10 determines the first position estimate and provides the first position estimate such that the mobile apparatus 20 receives the first position estimate, or vice versa. In an example embodiment, the first position estimate is obtained based at least in part on an indication of user input (e.g., received via user interface 28). For example, a user may interact with a graphical user interface provided via the user interface 28 that displays a floor plan and/or map of the building and/or venue and the user may interact with the graphical user interface to select the approximate location of the user (and the mobile apparatus 20) at the first time.

In various embodiments, the first position estimate is determined and/or generated (e.g., by the network apparatus 10, mobile apparatus 20, a (Cloud-based) positioning service, and/or the like) based at least in part on the first radio data (and/or a portion thereof) and a radio map corresponding to at least a portion of the building and/or venue. For example, the first position estimate is a radio-based positioning position estimate determined based at least in part on the first radio data and a radio map corresponding to at least a portion for the building and/or venue. In an example embodiment, the first position estimate is determined based on a hybrid positioning algorithm that takes into account motion data captured by various sensors 30 of the mobile apparatus 20, GNSS-based position fixes, the first radio data, and/or the like to determine and/or generate the first position estimate. Various other techniques may be used to generate and/or determine the first position estimate based at least in part on sensor data captured by one or more sensors 30 at the first time and/or user input received via user interface 28, in various embodiments.

At block 506, second radio data is obtained. For example, the network apparatus 10 and/or mobile apparatus 20 obtains second radio data. For example, the network apparatus 10 and/or mobile apparatus 20 comprises means, such as processor 12, 22, memory 14, 24, communications interface 16, 26, and/or the like. For example, the network apparatus 10 may receive the second radio data (e.g., via network 50 and/or communications interface 16).

In various embodiments, the second radio data comprises a second timestamp indicating that the second radio data corresponds to the radio environment observed by the mobile apparatus 20 (e.g., a radio sensor and/or radio interface 30 of the mobile apparatus 20) at the second time T2. The second radio data further comprises second observation information. In various embodiments, the second observation information comprises second radio node identifiers, each configured to identify a respective radio node observed by the mobile apparatus 20 at the second time. The second observation information further comprises respective observation characteristics that characterize the mobile apparatus's observation of each respective radio node identified by a respective second radio node identifier. In various embodiments, the observation characteristics that characterize the mobile apparatus's 20 observation of respective radio node include one or more of a signal strength indicator indicating the observed signal strength, a timing parameter (e.g., one-way time, round-trip-time, timing advance value, and/or the like), a frequency (band) or channel, and/or the like.

At block 508, a second position estimate is obtained. For example, the network apparatus 10 and/or mobile apparatus 20 obtains a second position estimate. In various embodiments, the second position estimate corresponds to a second location where the mobile apparatus 20 was located at the second time. In various embodiments, the second position estimate comprises a second horizontal position. The second horizontal position indicates the location of a two-dimensional projection of the second position estimate in a plane that is perpendicular to the vertical direction. For example, the second horizontal position may be a latitude and longitude estimating the second location. In another embodiment, the second horizontal position may be a two-dimensional position estimate in local and/or relative coordinates. For example, the network apparatus 10 and/or the mobile apparatus 20 comprises means, such as processor 12, 22, memory 14, 24, communications interface 16, 26, user interface 28, and/or the like, for obtaining the second position estimate.

In an example embodiment, the second position estimate is received (by the network apparatus 10 and/or mobile apparatus 20) via communications interface 16, 26. For example, the second position estimate may be determined and/or generated by a Cloud-based positioning service, and/or other positioning system which then provides the second position estimate such that the network apparatus 10 and/or the mobile apparatus 20 receives the second position estimate. In an example embodiment, the second position estimate is stored in memory 14, 24 and the network apparatus 10 and/or mobile apparatus 20 obtains the second position estimate by accessing the second position estimate from memory. In an example embodiment, the network apparatus 10 determines the second position estimate and provides the second position estimate such that the mobile apparatus 20 receives the second position estimate, or vice versa. In an example embodiment, the second position estimate is obtained based at least in part on an indication of user input (e.g., received via user interface 28). For example, a user may interact with a graphical user interface provided via the user interface 28 that displays a floor plan and/or map of the building and/or venue and the user may interact with the graphical user interface to select the approximate location of the user (and the mobile apparatus 20) at the second time.

In various embodiments, the second position estimate is determined and/or generated (e.g., by the network apparatus 10, mobile apparatus 20, a (Cloud-based) positioning service, and/or the like) based at least in part on the second radio data (or a portion thereof) and the radio map corresponding to at least a portion of the building and/or venue. For example, the second position estimate is a radio-based positioning position estimate determined based at least in part on the second radio data and the radio map corresponding to at least a portion for the building and/or venue. In an example embodiment, the second position estimate is determined based on a hybrid positioning algorithm that takes into account motion data captured by various sensors 30 of the mobile apparatus 20, GNSS-based position fixes, the second radio data, and/or the like to determine and/or generate the second position estimate. Various other techniques may be used to generate and/or determine the second position estimate based at least in part on sensor data captured by one or more sensors 30 at the second time and/or user input received via user interface 28, in various embodiments.

At block 510, it is determined whether the first horizontal position of the first position estimate and the second horizontal position of the second position estimate are substantially similar to one another. For example, the network apparatus 10 and/or the mobile apparats 20 determines whether the first horizontal position and the second horizontal position are substantially similar to one another. For example, the network apparatus 10 and/or the mobile apparatus 20 comprises means, such as processor 12, 22, memory 14, 24, and/or the like, for the determining whether the first horizontal position and the second horizontal position are substantially similar to one another.

In various embodiments, it is determined that the first horizontal position and the second horizontal position are substantially similar when the first horizontal position and the second horizontal position indicate at that the mobile apparatus 20 was located within the same building and/or venue at the first time and the second time. In various embodiments, it is determined that the first horizontal position and the second horizontal position are substantially similar when the first horizontal position and the second horizontal position are located within a threshold distance of one another. For example, in FIG. 3 the distance between the first horizontal position corresponding to the first location 310A and the second horizontal position corresponding to the second location 310B is the distance D. Thus, when D is less than the threshold distance, the first horizontal position and the second horizontal position are determined to be substantially similar.

In an example embodiment, the threshold distance is set such that the radio environment observed by the mobile apparatus 20 is expected to change very little over the threshold distance. For example, the threshold distance is less than an expected radius or diameter of the broadcast and/or coverage area of one or more of the radio nodes 40. In various embodiments, the threshold distance is determined based at least in part on a radio type (e.g., Wi-Fi, Bluetooth, cellular, and/or the like), frequency (range), channel, and/or other characteristic of the radio nodes 40 located within the building and/or venue and/or the radio type or other capabilities of the radio sensor 30 of the mobile apparatus 20. In various embodiments, the threshold distance is determined based at least in part on the broadcast and/or coverage areas of one or more radio nodes 40 located within the building and/or venue as indicated by the radio map corresponding to at least a portion of the building. In an example embodiment, the threshold distance is within a range of two to ten meters (e.g., four meters, for example). In an example embodiment, the threshold distance is determined based at least in part on the uncertainty in the first position estimate and/or the second position estimate (e.g., the uncertainty in the first horizontal position and/or the second horizontal position). For example, the threshold distance is set equal to (the larger of) the uncertainty in the first horizontal position and the uncertainty in the second horizontal position.

Continuing with FIG. 5, when it is determined, at block 510, that the first horizontal position and the second horizontal position are not substantially similar, the process may end, return to block 502, provide an indication that the first horizontal position and the second horizontal position are not substantially similar and/or that determination of whether the mobile apparatus 20 changed floors and/or levels between the first time and second time cannot be determined, and/or the like, in various embodiments.

When it is determined, at block 510, that the first horizontal position and the second horizontal position are substantially similar, the process continues to block 512. At block 512, it is determined whether the differences between the first radio data and the second radio data satisfy one or more threshold criteria. For example, the network apparatus 10 and/or the mobile apparatus 20 determines whether the differences between the first radio data and the second radio data satisfy one or more threshold criteria. For example, the network apparatus 10 and/or the mobile apparatus 20 comprises means, such as processor 12, 22, memory 14, 24, and/or the like, for determining whether the differences between the first radio data and the second radio data satisfy one or more threshold criteria.

For example, in various embodiments, when the number and/or percentage of radio nodes observed by the mobile apparatus 20 at the first time, as indicated by the first radio data, and were not observed by the mobile apparatus 20 at the second time, as indicated by the second radio data, is greater than a threshold number and/or percentage, it may be determined that the differences between the first radio data and the second radio data satisfy at least one of the one or more threshold criteria. For example, in various embodiments, when the number and/or percentage of radio nodes observed by the mobile apparatus 20 at the first time, as indicated by the first radio data, and were not observed by the mobile apparatus 20 at the second time, as indicated by the second radio data, is not greater than a threshold number and/or percentage, it may be determined that the differences between the first radio data and the second radio data do not satisfy at least one of the one or more threshold criteria.

For example, in various embodiments, when the number and/or percentage of radio nodes observed by the mobile apparatus 20 at the second time, as indicated by the second radio data, and were not observed by the mobile apparatus 20 at the first time, as indicated by the first radio data, is greater than a threshold number and/or percentage, it may be determined that the differences between the first radio data and the second radio data satisfy at least one of the one or more threshold criteria. For example, in various embodiments, when the number and/or percentage of radio nodes observed by the mobile apparatus 20 at the second time, as indicated by the second radio data, and were not observed by the mobile apparatus 20 at the first time, as indicated by the first radio data, is not greater than a threshold number and/or percentage, it may be determined that the differences between the first radio data and the second radio data do not satisfy at least one of the one or more threshold criteria.

For example, in the example illustrated in FIG. 3, the first radio node 40A was observed at the first time by the mobile apparatus 20, as indicated by first radio data 320A, but the first radio node 40A was not observed by the mobile apparatus 20 as the second time, as indicated by the second radio data 320B. Similarly, the second radio data 320B indicates that the fourth radio node 40D was observed by the mobile apparatus 20 at the second time and the first radio data 320A indicates that the fourth radio node 40D was not observed by the mobile apparatus 20 at the first time. Thus, in an example embodiment, based on the differences in which radio nodes 40 were observed at the first time and the second time, it may be determined that the mobile apparatus 20 changed floors and/or levels within the building 300 between the first time and the second time.

For example, in various embodiments, when the observed signal strength and/or timing parameter of one or more radio nodes observed by the mobile apparatus 20 at both the first time and the second time, as indicated by the first radio data and the second radio data, change by more than a respective characteristic change and/or percentage between the first time and the second time, it may be determined that the differences between the first radio data and the second radio data satisfy at least one of the one or more threshold criteria. In an example embodiment, the respective characteristic change and/or percentage is configured to indicate a statistically significant change in the characteristics over the observed and/or expected noise for the respective characteristic. For example, when the respective characteristic is observed signal strength, a noise level of +/−5 dB may be expected. In such embodiments, the respective characteristics change and/or percentage may correspond to a change of +/−5 dB or more in the observed signal strength of a particular radio node 40 between the first radio data and the second radio data. Thus, returning to the example of FIG. 3, the first radio data 320A indicates that the second radio node 40B was observed with an observed signal strength of 20 dB at the first time and the second radio data 320B indicates that the second radio node 40B was observed with an observed signal strength of 10 dB at the second time. As the change in the absolute value difference in the observed signal strength of the second radio node 40B between the first radio data 320A and the second radio data 320B is greater than the respective characteristic change (e.g., 5 dB in this example), it is determined that the differences between the first radio data and the second radio data satisfy at least one of the one or more threshold criteria.

Conversely, when it is determined that the observed signal strength and/or timing parameter of one or more radio nodes observed by the mobile apparatus 20 at both the first time and the second time, as indicated by the first radio data and the second radio data, is generally stable (e.g., does not change by more than a respective characteristic change and/or percentage) between the first time and the second time, it may be determined that the differences between the first radio data and the second radio data do not satisfy at least one of the one or more threshold criteria.

In various embodiments, a radio map corresponding to at least a portion of a building and/or venue includes positioning-enabling information corresponding to at least some of the radio nodes 40 disposed within the building and/or venue. However, the radio map may not include positioning-enabling information for every radio node 40 disposed within the building. In various embodiments, positioning-enabling information corresponding to a respective radio node 40 is information that, when the respective radio node 40 is observed by the mobile apparatus 20, the observation of the respective radio node 40 and/or one or more characteristics of the observation of the respective radio node 40 by the mobile apparatus 20 may be used to determine a radio-based position estimate for the mobile apparatus 20. For example, the positioning-enabling information for a respective radio node may include a location of the respective radio node, expected observed signal strengths corresponding to the respective radio node at various locations, and/or the like.

In various embodiments, the first position estimate is determined based at least in part on the first radio data. The first position estimate is associated with an indication of which radio nodes corresponding to respective first radio node identifiers where used to determine the first position estimate. For example, the first position estimate is determined based on radio nodes corresponding to respective first radio node identifiers for which the radio map includes corresponding positioning-enabling information. Similarly, in various embodiments, the second position estimate is determined based at least in part on the second radio data. The second position estimate is associated with an indication of which radio nodes corresponding to respective second radio node identifiers where used to determine the second position estimate. For example, the second position estimate is determined based on radio nodes corresponding to respective second radio node identifiers for which the radio map includes corresponding positioning-enabling information.

Thus, the first radio data comprises first radio node identifiers which may be split into a map-included subset and a not-map-included subset. The map-included subset and the not-map-included subset of the first radio node identifiers do not overlap. The radio node identifiers of the first radio node identifiers that are associated with the map-included subset identify radio nodes that were used to determine the first position estimate and/or for which the radio map includes position-enabling information. The radio node identifiers of the first radio node identifiers that are associated with the not-map-included subset identify radio nodes that were not used to determine the first position estimate and/or for which the radio map does not include position-enabling information. Similarly, the second radio data comprises second radio node identifiers which may be split into a map-included subset and a not-map-included subset. The map-included subset and the not-map-included subset of the second radio node identifiers do not overlap.

When the number of radio node identifiers in the map-included subset of the first radio node identifiers and/or the map-included subset of the second radio node identifiers is at least a minimum set size number, the radio node identifiers in the not-map-included subset of the first radio node identifiers and/or the not-map-included subset of the second radio node identifiers and/or the corresponding respective observation characteristics are not used when determining whether the differences between first radio data and the second radio data satisfy the one or more threshold criteria, in various embodiments. When the number of radio node identifiers in the map-included subset of the first radio node identifiers and/or the map-included subset of the second radio node identifiers is smaller than the minimum set size number, the radio node identifiers in the not-map-included subset of the first radio node identifiers and/or the not-map-included subset of the second radio node identifiers and/or the corresponding respective observation characteristics are used when determining whether the differences between first radio data and the second radio data satisfy the one or more threshold criteria, in various embodiments.

For example, for the radio map 330, the map-included subset for the first radio node identifiers includes the identifier for the second radio node 40B and the identifier for the third radio node 40C and the not-map-included subset of the first radio node identifiers includes the identifier for the first radio node 40A. Moreover, the map-included subset for the second radio node identifiers includes the identifier for the second radio node 40B and the identifier for the third radio node 40C and the not-map-included subset of the second radio node identifiers includes the identifier for the fourth radio node 40D. Thus, for example, when the minimum set size number is two, it is determined whether the differences between the first radio data and the second radio data satisfy the one or more threshold criteria based on only the observations of the second radio node 40B and the third radio node 40C by the mobile apparatus 20. In another example, when the minimum set size number is greater than two, it is determined whether the differences between the first radio data and the second radio data satisfy the one or more threshold criteria based on both the map-included subsets and the not-map-included subsets of the first radio node identifiers and the second radio node identifiers and the corresponding observation characteristics indicated by the first radio data and/or the second radio data, respectively, in an example embodiment.

In various embodiments, block 510 and block 512 may be performed simultaneously and/or substantially at the same. For example, a determination of whether the first horizontal position and the second horizontal position are substantially similar may be performed in parallel with a determination of whether the differences between the first radio data and the second radio data satisfy the one or more threshold criteria. In an example embodiment, block 512 is performed before the performance of block 510. For example, a determination of whether the first horizontal position and the second horizontal position are substantially similar is performed as a result of and/or responsive to determining that the differences between the first radio data and the second radio data satisfy the one or more threshold criteria, in an example embodiment.

Continuing with FIG. 5, when it is determined at block 512 that the differences between the first radio data and the second radio data satisfy the one or more threshold criteria, the process continues to block 514. At block 514, the network apparatus 10 and/or mobile apparatus 20 determines that the mobile apparatus 20 changed floors and/or levels within the building and/or venue between the first time and the second time. For example, responsive to and/or based at least in part on determining that the differences between the first radio data and the second radio data satisfy at least one of the one or more threshold criteria (and that the first horizontal position and the second horizontal position are substantially similar), it is determined that the mobile apparatus 20 changed floors and/or levels within the building and/or venue between the first time and the second time. For example, the network apparatus 10 and/or the mobile apparatus 20 comprises means, such as processor 12, 22, memory 14, 24, and/or the like, for determining that the mobile apparatus 20 changed floors and/or levels within the building and/or venue between the first time and the second time. In an example embodiment, when it is determined (in parallel or in series) that the first horizontal position and the second horizontal position are substantially similar and that the differences between the first radio data and the second radio data satisfy the one or more threshold criteria, it is determined that the mobile apparatus 20 changed floors and/or levels within the building and/or venue between the first time and the second time.

When it is determined at block 512 that the differences between the first radio data and the second radio data satisfy the one or more threshold criteria, the process continues to block 516. At block 516, the network apparatus 10 and/or mobile apparatus 20 determines that the mobile apparatus 20 did not change floors and/or levels within the building and/or venue between the first time and the second time. For example, responsive to and/or based at least in part on determining that the differences between the first radio data and the second radio data do not satisfy at least one of the one or more threshold criteria, it is determined that the mobile apparatus 20 did not change floors and/or levels within the building and/or venue between the first time and the second time. For example, the network apparatus 10 and/or the mobile apparatus 20 comprises means, such as processor 12, 22, memory 14, 24, and/or the like, for determining that the mobile apparatus 20 did not change floors and/or levels within the building and/or venue between the first time and the second time.

At block 518, an indication of whether the mobile apparatus changed floors and/or levels within the building and/or venue between the first time and the second time is generated and/or provided, in various embodiments. For example, the network apparatus 10 and/or mobile apparatus 20 generates and/or provides an indication of whether the mobile apparatus changed floors and/or levels within the building and/or venue between the first time and the second time. For example, the network apparatus 10 and/or mobile apparatus 20 comprises means, such as processor 12, 22, memory 14, 24, communication interface 16, 26, user interface 18, 28, and/or the like, for generating and providing an indication of whether the mobile apparatus 20 changed floors and/or levels within the building and/or venue between the first time and the second time.

For example, when it is determined that the mobile apparatus 20 changed floors and/or levels within the building and/or venue between the first time and the second time, the indication indicates and/or signals that the mobile apparatus 20 changed floors and/or levels within the building and/or venue between the first time and the second time. For example, when it is determined that the mobile apparatus 20 did not change floors and/or levels within the building and/or venue between the first time and the second time, the indication indicates and/or signals that the mobile apparatus 20 did not change floors and/or levels within the building and/or venue between the first time and the second time.

For example, the indication of whether the mobile apparatus changed floors and/or levels may be provided as an API call, an API response (e.g., in response to an API call requesting a floor change determination be made), as a push notification, and/or the like. In an example embodiment, the network apparatus 10 generates and provides (e.g., transmits) the indication such that the mobile apparatus 20 receives the indication (e.g., via network 50). In an example embodiment, the mobile apparatus 20 provides (e.g., transmits) the indication such that the network apparatus 10 receives the indication. In an example embodiment, a floor change determination application, program and/or module operating and/or executing on the network apparatus 10 and/or mobile apparatus 20 generates and provides the indication and another application, program and/or module operating and/or executing on the network apparatus 10 and/or mobile apparatus 20 receives the indication.

At block 520, the network apparatus 10 and/or the mobile apparatus 20 uses the indication of whether the mobile apparatus 20 changed floors and/or levels within the building and/or venue between the first time and the second time to perform one or more positioning and/or navigation-related functions. In various embodiments, the one or more positioning and/or navigation-related functions comprise one or more of determining a position estimate for the mobile apparatus 20, displaying a position estimate via a user interface 28, route determination, route guidance, radio environment learning (e.g., updating a radio map to associate a radio node with a particular floor of the building and/or venue, and/or the like), confirming a floor change detection determined and/or identified based on motion and/or environmental sensor data (e.g., barometric pressure data and/or acceleration data), and/or the like. For example, the network apparatus 10 and/or mobile apparatus 20 comprises means, such as processor 12, 22, memory 14, 24, communication interface 16, 26, user interface 28, and/or the like, for performing one or more positioning and/or navigation-related functions based at least in part on the indication of whether mobile apparatus 20 changed floors and/or levels within the building and/or venue between the first time and the second time. For example, the network apparatus 10 may determine a route for the mobile apparatus 20 based at least in part on the indication and provide the route such that the mobile apparatus 20 receives the route. The mobile apparatus 20 may then provide route guidance along the route (e.g., display at least a portion of the route overlaid on a map of at least a portion of the building and/or venue via user interface 28) based at least in part on the indication.

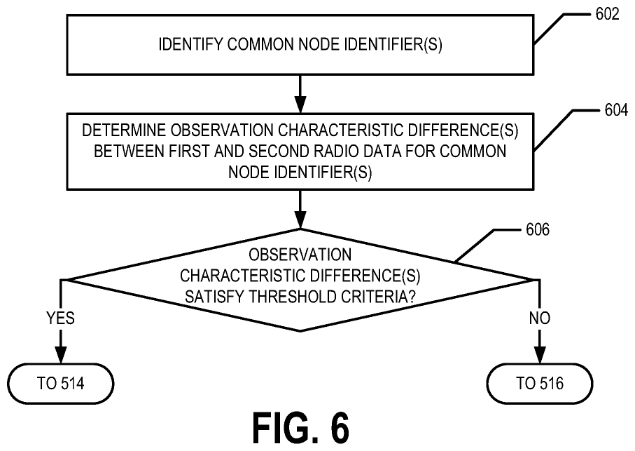

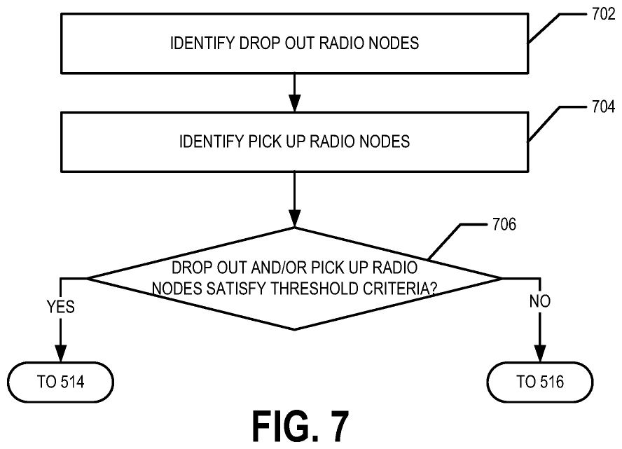

FIGS. 6 and 7 each provide a respective flowchart of various processes, procedures, operations, and/or the like that may be performed to determine whether at least one of the one or more threshold criteria is satisfied by the differences between the first radio data and the second radio data. For example, the processes, procedures, operations, and/or the like illustrated in FIG. 6 and/or FIG. 7 may be performed as part of block 512, in various embodiments.

Starting with block 602 of FIG. 6, one or more common node identifiers are identified. Common node identifiers are radio node identifiers that are included in both the first radio node identifiers of the first radio data and the second radio node identifiers of the second radio data. For example, for the example illustrated in FIG. 3, the identifier for the second radio node 40B and the identifier for the third radio node 40C are the common node identifiers and the identifiers for the first and fourth radio nodes 40A, 40D are not common node identifiers. For example, the network apparatus 10 and/or the mobile apparatus 20 identifies the common node identifiers present in both the first radio node identifiers of the first radio data and the second radio node identifiers of the second radio data. For example, the network apparatus 10 and/or the mobile apparatus 20 comprise means, such as processor 12, 22, memory 14, 24, and/or the like, for identifying the common node identifiers present in both the first radio node identifiers of the first radio data and the second radio node identifiers of the second radio data.

Continuing with FIG. 6, at block 604, at least one observation characteristic difference between the first radio data and the second radio data for at least one common node identifier. For example, a signal strength difference between the first radio data and the second radio data may be determined for a first common node identifier by determining the difference between the observed signal strength associated with the first common node identifier in the first radio data and the observed signal strength associated with the first common node identifier in the second radio data. For example, a round-trip-time difference between the first radio data and the second radio data may be determined for a first common node identifier by determining the difference between the observed round-trip-time associated with the first common node identifier in the first radio data and the observed round-trip-time associated with the first common node identifier in the second radio data. For example, the network apparatus 10 and/or mobile apparatus 20 determined one or more observation characteristic differences between the first radio data and the second radio data for at least one of the one or more common node identifiers. For example, the network apparatus 10 and/or mobile apparatus 20 comprises means, such as processor 12, 22, memory 14, 24, and/or the like, for determining one or more observation characteristic differences between the first radio data and the second radio data for at least one of the one or more common node identifiers.

For example, for the example illustrated in FIG. 3, an observed signal strength difference of −10 dB is determined for the second radio node 40B and an observed signal strength difference of +10 dB is determined for the third radio node 40C. Based on such it may be determined, in an example embodiment, that mobile apparatus 10, while at substantially similar horizontal positions, moved closer to the third radio node 40C and further from the second radio node 40B between the first time and the second time. For example, when it is determined that the mobile apparatus 20 changed floors and/or levels within the building and/or venue between the first time and the second time, it may be determined that the second radio node 40B is disposed on and/or located closer to the floor the mobile apparatus 20 was located on at the first time and the third radio node 40C is disposed on and/or located closer to the floor the mobile apparatus 20 was located on at the second time.

Continuing with FIG. 6, at block 606, it is determined whether the observation characteristic differences satisfy a respective threshold criteria. For example, it may be determined whether the observation characteristic difference is greater than a respective characteristics change and/or percentage. For example, it may be determined whether the observed signal strength difference for a first common radio node is greater than a signal strength change. In an example embodiment, the signal strength change is determined based on observed and/or expected noise in the observed signal strength measurements captured by the mobile apparatus 20. For example, it may be determined whether the observed round-trip-time differences for a first common radio node is greater than a round-trip-time change. In an example embodiment, the round-trip-time change is determined based on observed and/or expected noise in the observed round-trip-time measurements captured by the mobile apparatus 20. For example, the network apparatus 10 and/or mobile apparatus 20 determines whether the observation characteristic differences satisfy a respective threshold criteria. For examples, the network apparatus 10 and/or mobile apparatus 20 comprise means, such as processor 12, 22, memory 14, 24, and/or the like, for determining whether the observation characteristic differences satisfy a respective threshold criteria.

When it is determined, at block 606, that at least a minimum number and/or a minimum percentage of the observation characteristic differences satisfy a respective threshold criteria, it is determined that at least one of the one or more threshold criteria are satisfied. For example, in such a scenario the process may continue to block 514.

When it is determined at block 606, that that less than a minimum number and/or a minimum percentage of the observation characteristic differences satisfy a respective threshold criteria, it is determined that at least one of the one or more threshold criteria is not satisfied. For example, in such a scenario the process may continue to block 516.

With respect to FIG. 7, at block 702, drop out radio nodes are identified 702. As used herein, drop out radio nodes are radio nodes for which a radio node identifier is present in the first radio node identifiers of the first radio data but is not present in the second radio node identifiers for the second radio data.

Continuing to block 704 of FIG. 7, pick up radio nodes are identified. As used herein, pick up radio nodes are radio nodes for which a radio node identifier is present in the second radio node identifiers of the second radio data but is not present in the first radio node identifiers for the first radio data. For example, the network apparatus 10 and/or mobile apparatus 20 identifies pick up radio nodes. For example, the network apparatus 10 and/or mobile apparatus 20 comprises means, such as processor 12, 22, memory 14, 24, and/or the like, for identifying pick up radio nodes. For example, in the example illustrated in FIG. 3, the fourth radio node 40D is a pick up radio node.

Continuing to block 706 of FIG. 7, is determined whether the drop out and/or pick up radio nodes satisfy respective threshold criteria. For example, when it is determined the number of drop out radio nodes is at least a minimum number of drop outs and/or that the percentage of the radio nodes observed by the mobile apparatus 20 at the first time that are drop out radio nodes is at least a minimum percentage of drop outs, it is determined that the drop out radio nodes satisfy a corresponding threshold criteria, in an example embodiment. For example, when it is determined the number of drop out radio nodes is less than a minimum number of drop outs and/or that the percentage of the radio nodes observed by the mobile apparatus 20 at the first time that are drop out radio nodes is less than a minimum percentage of drop outs, it is determined that the drop out radio nodes do not satisfy a corresponding threshold criteria, in an example embodiment. For example, when it is determined the number of pick up radio nodes is at least a minimum number of pick ups and/or that the percentage of the radio nodes observed by the mobile apparatus 20 at the second time that are pick up radio nodes is at least a minimum percentage of pick ups, it is determined that the pick up radio nodes satisfy a corresponding threshold criteria, in an example embodiment. For example, when it is determined the number of pick up radio nodes is less than a minimum number of pick ups and/or that the percentage of the radio nodes observed by the mobile apparatus 20 at the second time that are pick up radio nodes is less than a minimum percentage of pick ups, it is determined that the pick up radio nodes do not satisfy a corresponding threshold criteria, in an example embodiment.

For example, the network apparatus 10 and/or mobile apparatus 20 determines whether the drop out and/or pick up radio nodes satisfy respective threshold criteria. For examples, the network apparatus 10 and/or mobile apparatus 20 comprise means, such as processor 12, 22, memory 14, 24, and/or the like, for determining whether the drop out and/or pick up radio nodes satisfy respective threshold criteria.

When it is determined, at block 706, that at least one of the drop out and/or pick up radio nodes satisfy a respective threshold criteria, it is determined that at least one of the one or more threshold criteria are satisfied. For example, in such a scenario the process may continue to block 514.

When it is determined at block 706, that at least one of an/or both of the drop out and/or pick up radio nodes did not satisfy a respective threshold criteria, it is determined that at least one of the one or more threshold criteria is not satisfied. For example, in such a scenario the process may continue to block 516.

### III. Technical Advantages

Various embodiments provide technical solutions to the technical problem of determining whether a mobile apparatus has changed floors and/or levels within a building and/or venue. Moreover, various embodiments provide technical solutions to the technical problem of determining whether a mobile apparatus has changed floors and/or levels within a building and/or venue independent of motion (e.g., acceleration data) and/or environmental sensor data (e.g., barometric pressure data). In particular, first radio data characterizing the radio environment observed by the mobile apparatus 20 at a first time is captured and second radio data characterizing the radio environment observed by the mobile apparatus 20 at a second time is captured. When it is determined that the horizontal position of the mobile apparatus 20 is substantially the same at the first time and the second time (e.g., the first and second horizontal positions are within a threshold distance of one another such that the radio environment is expected to not substantively change, the first horizontal position is within the uncertainty region about the second horizontal position or vice versa, the mobile apparatus is located within the same building and/or venue, and/or the like), it may be determined whether the first radio data and the second radio data are substantively similar or not (e.g., based on whether the differences between the first radio data and the second radio data satisfy one or more threshold criteria). When the first radio data and the second radio data are determined to be substantively similar (e.g., the differences between the first radio data and the second radio data do not satisfy the one or more threshold criteria), it is determined that the mobile apparatus 20 did not change floors within the building and/or venue between the first time and the second time. When the first radio data and the second radio data are determined to not be substantively similar (e.g., the differences between the first radio data and the second radio data do satisfy the one or more threshold criteria), it is determined that the mobile apparatus 20 did change floors within the building and/or venue between the first time and the second time.

Various embodiments, therefore, provide a technique for determining whether a mobile apparatus has changed floors and/or levels within a building and/or venue that is independent of barometric pressure data and/or accelerometer data. Thus, the change in radio environment determination of whether a mobile apparatus has changed floors and/or levels within a building and/or venue disclosed herein may be used independently (e.g., in situations where barometric data and/or accelerometer data are not available and/or reliable) and/or to confirm a floor change determination that was determined based on barometric pressure data and/or accelerometer data, for example.

As these floor change determinations may be used to perform one or more positioning and/or navigation-related functions corresponding to the mobile apparatus (e.g., tracking the mobile apparatus's location within the building and/or venue, determining the location of the mobile apparatus within the building and/or venue, determining a route that is at least partially within the building and/or venue, providing route guidance for a route that is at least partially within the building and/or venue, updating a radio map corresponding to at least a portion of the building and/or venue, and/or the like), various embodiments provide improvements to the technical field of indoor positioning and/or navigation.

Additionally, various embodiments enable the use of radio nodes for which positioning-enabling information is not provided by the radio map corresponding to at least a portion of the building and/or venue. Thus, observations of radio nodes that are not used to determine the first and second position estimates may still be used in the determination of whether the mobile apparatus 20 changed floors and/or levels within the building and/or venue between eh first time and the second time. Thus, in scenarios where the radio map is sparce and/or where the bandwidth used to transmit radio data to a positioning service is small, a larger sampling of the respective radio environments observed by the mobile apparatus 20 at the first time and the second time can be used to determine whether the mobile apparatus 20 changed floors and/or levels within the building and/or venue between the first time and the second time. Thus, even when the radio map is sparce and/or the bandwidth used to transmit radio data to a positioning service is small, various embodiments still enable a robust determination of whether the mobile apparatus 20 changed floors and/or levels within the building and/or venue between the first time and the second time. Thus, various embodiments provide additional improvements to the field of indoor positioning and/or navigation.

### IV. Example Apparatus

The network apparatus 10 and/or mobile apparatus 20 of an example embodiment may be embodied by or associated with a variety of computing devices including, for example, a navigation system, a personal navigation device (PND) or a portable navigation device, a global navigation satellite system (GNSS), a cellular telephone, a mobile phone, a personal digital assistant (PDA), a tablet, a watch, a camera, a computer, and/or other device that can perform positioning and/or navigation-related functions, such as (radio-based) positioning, digital routing, and/or map display. Additionally or alternatively, the network apparatus 10 and/or mobile apparatus 20 may be embodied in other types of computing devices, such as a server, a personal computer, a computer workstation, a laptop computer, a plurality of networked computing devices or the like, that are configured to obtain first radio data and second radio data, obtain a first position estimate and a second position estimate, determine whether differences between the first radio data and the second radio satisfy one or more threshold criteria are satisfied, update a radio map, and/or the like. In an example embodiment, a mobile apparatus 20 is a smartphone, tablet or other mobile computing entity and a network apparatus 10 is a server. In an example embodiment, a mobile apparatus 20 is an apparatus configured to provide a user with a route (e.g., via user interface 28).

In some embodiments, the processor 12, 22 (and/or co-processors or any other processing circuitry assisting or otherwise associated with the processor) may be in communication with the memory device 14, 24 via a bus for passing information among components of the apparatus. The memory device may be non-transitory and may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the network apparatus 10 and/or mobile apparatus 20 may be embodied by a computing device. However, in some embodiments, the network apparatus 10 and/or mobile apparatus 20 may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22 may be embodied in a number of different ways. For example, the processor 12, 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 12, 22 may include one or more processing cores configured to perform independently. A multi-core processor may enable multiprocessing within a single physical package. Additionally or alternatively, the processor 12, 22 may include one or more processors configured in tandem via the bus to enable independent execution of instructions, pipelining and/or multithreading.

In an example embodiment, the processor 12, 22 may be configured to execute instructions stored in the memory device 14, 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the network apparatus 10 and/or mobile apparatus 20 may include a user interface 18, 28 that may, in turn, be in communication with the processor 12, 22 to provide output to the user, such as one or more navigable routes through a road network and/or venue, one or more notifications regarding traffic conditions along at least a portion of a route, and/or the output of one or more other navigation functions, and, in some embodiments, to receive an indication of a user input. As such, the user interface 18, 28 may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 12, 22 (e.g., memory device 14, 24 and/or the like).

The network apparatus 10 and/or mobile apparatus 20 may optionally include a communication interface 16, 26. The communication interface 16, 26 may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In addition to embodying the network apparatus 10 and/or mobile apparatus 20 of an example embodiment, a navigation system may also include or have access to a geographic database. For example, in various embodiments, a network apparatus 10 and/or mobile apparatus 20 may comprise a component (e.g., memory 14, 24, and/or another component) that stores a digital map (e.g., in the form of a geographic database) comprising a first plurality of data records. In various embodiments, each of the first plurality of data records representing a corresponding TME, wherein at least some of said first plurality of data records map information/data (e.g., the updated map information/data) indicating current traffic conditions along the corresponding TME. In various embodiments, a TME may be a road segment, a traversable lane of a road network, a segment of a pedestrian or bike path, a walkable and/or traversable indoor segment (e.g., within a building and/or venue), and/or the like. For example, the geographic database may include a variety of data (e.g., map information/data) utilized in various navigation functions such as constructing a route or navigation path, determining the time to traverse the route or navigation path, matching a geolocation (e.g., a GNSS determined location) to a point on a map, a lane of a lane network, and/or link, one or more localization features and a corresponding location of each localization feature, and/or the like. For example, a geographic database may include road segment, segment, link, lane segment, or traversable map element (TME) data records, point of interest (POI) data records, localization feature data records, and other data records. In various embodiments, the geographic database comprises a radio map comprising radio models that each represent the coverage area and/or transmission properties of a respective radio node.

More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, POI data records, and/or other data records. In an example embodiment, the network apparatus 10 may be configured to modify, update, and/or the like one or more data records of the geographic database. For example, the network apparatus 10 may modify, update, generate, and/or the like map information/data corresponding to TMEs, links, lanes, road segments, travel lanes of road segments, nodes, intersection, radio nodes, and/or the like and/or the corresponding data records (e.g., to add or update updated map information/data including, for example, current events and/or conditions along a corresponding TME), a localization layer (e.g., comprising localization features) and/or the corresponding data records, and/or the like.

In an example embodiment, the TME data records are links, lanes, or segments (e.g., maneuvers of a maneuver graph, representing roads, travel lanes of roads, streets, or paths (e.g., pedestrian paths, bike paths, and/or the like), as can be used in the calculated route or recorded route information for determination of one or more personalized routes). The intersection data records are ending points corresponding to the respective links, lanes, or segments of the TME data records. The TME data records and the intersection data records represent a road network, such as used by vehicles, cars, bicycles, and/or other entities. Alternatively, the geographic database can contain path segment and intersection data records or nodes and connection information/data or other data that represent pedestrian paths or areas in addition to or instead of the vehicle road record data, for example.

The TMEs, lane/road/link segments, segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases. Regardless of the manner in which the databases are compiled and maintained, a navigation system that embodies a network apparatus 10 and/or mobile apparatus 20 in accordance with an example embodiment may determine the time to traverse a route that includes one or more turns at respective intersections more accurately.

### V. Apparatus, Methods, and Computer Program Products

As described above, FIGS. 4, 5, 6, and 7 illustrate flowcharts of a network apparatus 10 and/or mobile apparatus 20, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24 of an apparatus employing an embodiment of the present invention and executed by the processor 12, 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
obtaining, by one or more processors, first radio data comprising one or more first radio node identifiers, each first radio node identifier associated with a respective first observed signal strength characterizing an observation made by a radio sensor of a mobile apparatus at the first time of a respective first radio node identified by a respective one of the first radio node identifiers;
obtaining, by the one or more processors, a first position estimate for the mobile apparatus, the first position estimate corresponding to a first horizontal position of a first location where the mobile apparatus was located at the first time;
obtaining, by the one or more processors, second radio data comprising one or more second radio node identifiers, each second radio node identifier associated with a respective second observed signal strength characterizing an observation made by the radio sensor of the mobile apparatus at a second time of a respective second radio node identified by a respective one of the second radio node identifiers;
obtaining, by the one or more processors, a second position estimate for the mobile apparatus, the second position estimate corresponding to a second horizontal position of a second location where the mobile apparatus was located at the second time;
responsive to determining that the first horizontal position and the second horizontal position are substantially similar, identifying, by the one or more processors, differences between the first radio data and the second radio data; and
based at least in part on the differences between the first radio data and the second radio data and one or more threshold criteria, determining, by the one or more processors, whether the first location and the second location are located on different floors.

2. The method of claim 1, wherein identifying differences between the first radio data and the second radio data comprises:
identifying at least one common radio node identifier present in both (a) the one or more first radio node identifiers and (b) the one or more second radio node identifiers; and
for the at least one common radio node identifier, determining a signal strength difference between the respective first observed signal strength and the respective second observed signal strength,
wherein determining whether the one or more threshold criteria are satisfied is based at least in part on the signal strength difference.

3. The method of claim 2, wherein it is determined that a threshold criteria of the one or more threshold criteria is satisfied when the signal strength difference is greater than a threshold difference.

4. The method of claim 3, wherein the threshold difference is determined based on at least one of (a) an observed noise level or (b) an expected noise level.

5. The method of claim 1, wherein identifying differences between the first radio data and the second radio data comprises:
determining at least one of:
a first number of identifiers that are present in the one or more first radio node identifiers that are not present in the one or more second radio node identifiers, or
a second number of identifiers that are present in the one or more second radio node identifiers that are not present in the one or more first radio node identifiers; and
determining whether the one or more threshold criteria are satisfied based at least in part on the first number or the second number.

6. The method of claim 5, wherein it is determined that a threshold criteria of the one or more threshold criteria is satisfied when at least one of (a) the first number or the second number is greater than a threshold number or (b) the first number is a greater percentage of a number of radio identifiers in the one or more first radio node identifiers than a threshold percentage or the second number is a greater percentage of a number of radio node identifiers in the one or more second radio node identifiers.

7. The method of claim 1, wherein the first position estimate is determined based at least in part on a map-included subset of the first radio data and the second position estimate is determined based at least in part on a map-included subset of the second radio data, wherein the respective map-included subsets of the first radio data and the second radio data correspond to radio nodes for which positioning-enabled information is provided by a radio map accessible to the one or more processors.

8. The method of claim 7, wherein determining whether the one or more threshold criteria are satisfied comprises determining differences between a not-map-included subset of the first radio data and a not-map-included subset of the second radio data, wherein the respective not-map-included subsets of the first radio data and the second radio data correspond to radio nodes for which positioning-enabled information is not provided by the radio map.

9. The method of claim 1, further comprising:
when it is determined that the first location and the second location are located on different floors, providing an indication that the mobile apparatus changed floors; and
when it is determined that the first location and the second location are not located on different floors, providing an indication that the mobile apparatus did not change floors.

10. The method of claim 1, further comprising at least one of:
using the determination of whether the first location and the second location are located on different floors to either confirm or not confirm a floor change determination determined based on at least one of environmental sensor data or motion sensor data captured by respective sensors of the mobile apparatus; or
tracking the floor one which the mobile apparatus is located based at least in part on the determination of whether the first location and the second location are located on different floors.

11. An apparatus comprising at least one processor and at least one memory storing computer program code, the at least one memory and the computer program code configured to, with the processor, cause the apparatus to at least:
obtain first radio data comprising one or more first radio node identifiers, each first radio node identifier associated with a respective first observed signal strength characterizing an observation made by a radio sensor of a mobile apparatus at the first time of a respective first radio node identified by a respective one of the first radio node identifiers;
obtain a first position estimate for the mobile apparatus, the first position estimate corresponding to a first horizontal position of a first location where the mobile apparatus was located at the first time;
obtain second radio data comprising one or more second radio node identifiers, each second radio node identifier associated with a respective second observed signal strength characterizing an observation made by the radio sensor of the mobile apparatus at a second time of a respective second radio node identified by a respective one of the second radio node identifiers;
obtain a second position estimate for the mobile apparatus, the second position estimate corresponding to a second horizontal position of a second location where the mobile apparatus was located at the second time;
determine that (i) the first horizontal position and the second horizontal position are substantially similar and (ii) there are one or more differences between the first radio data and the second radio data that satisfy one or more threshold criteria; and
based at least in part on the determination that (i) the first horizontal position and the second horizontal position are substantially similar and (ii) there are one or more differences between the first radio data and the second radio data that satisfy one or more threshold criteria, determine that the first location and the second location are located on different floors.

12. The apparatus of claim 11, wherein identifying differences between the first radio data and the second radio data comprises:
identifying at least one common radio node identifier present in both (a) the one or more first radio node identifiers and (b) the one or more second radio node identifiers; and
for the at least one common radio node identifier, determining a signal strength difference between the respective first observed signal strength and the respective second observed signal strength,
wherein determining whether the one or more threshold criteria are satisfied is based at least in part on the signal strength difference.

13. The apparatus of claim 11, wherein it is determined that a threshold criteria of the one or more threshold criteria is satisfied when the signal strength difference is greater than a threshold difference.

14. The apparatus of claim 13, wherein the threshold difference is determined based on at least one of (a) an observed noise level or (b) an expected noise level.

15. The apparatus of claim 11, wherein identifying differences between the first radio data and the second radio data comprises:
determining at least one of:
a first number of identifiers that are present in the one or more first radio node identifiers that are not present in the one or more second radio node identifiers, or
a second number of identifiers that are present in the one or more second radio node identifiers that are not present in the one or more first radio node identifiers; and
determining whether the one or more threshold criteria are satisfied based at least in part on the first number or the second number.

16. The apparatus of claim 15, wherein it is determined that a threshold criteria of the one or more threshold criteria is satisfied when at least one of (a) the first number or the second number is greater than a threshold number or (b) the first number is a greater percentage of a number of radio identifiers in the one or more first radio node identifiers than a threshold percentage or the second number is a greater percentage of a number of radio node identifiers in the one or more second radio node identifiers.

17. The apparatus of claim 11, wherein the first position estimate is determined based at least in part on a map-included subset of the first radio data and the second position estimate is determined based at least in part on a map-included subset of the second radio data, wherein the respective map-included subsets of the first radio data and the second radio data correspond to radio nodes for which positioning-enabled information is provided by a radio map accessible to the one or more processors.

18. The apparatus of claim 17, wherein determining whether the one or more threshold criteria are satisfied comprises determining differences between a not-map-included subset of the first radio data and a not-map-included subset of the second radio data, wherein the respective not-map-included subsets of the first radio data and the second radio data correspond to radio nodes for which positioning-enabled information is not provided by the radio map.

19. The apparatus of claim 11, wherein the at least one memory and the computer program code are further configured to, with the processor, cause the apparatus to perform at least one of:
when it is determined that the first location and the second location are located on different floors, provide an indication that the mobile apparatus changed floors;
when it is determined that the first location and the second location are not located on different floors, provide an indication that the mobile apparatus did not change floors;
use the determination of whether the first location and the second location are located on different floors to either confirm or not confirm a floor change determination determined based on at least one of environmental sensor data or motion sensor data captured by respective sensors of the mobile apparatus; or
tracking the floor one which the mobile apparatus is located based at least in part on the determination of whether the first location and the second location are located on different floors.

20. A computer program product comprising at least one non-transitory computer-readable storage medium having computer-readable program code portions stored therein, the computer-readable program code portions comprising executable portions configured, when executed by a processor of an apparatus, to cause the apparatus to:
obtain first radio data comprising one or more first radio node identifiers, each first radio node identifier associated with a respective first observed signal strength characterizing an observation made by a radio sensor of a mobile apparatus at the first time of a respective first radio node identified by a respective one of the first radio node identifiers;
obtain a first position estimate for the mobile apparatus, the first position estimate corresponding to a first horizontal position of a first location where the mobile apparatus was located at the first time;
obtain second radio data comprising one or more second radio node identifiers, each second radio node identifier associated with a respective second observed signal strength characterizing an observation made by the radio sensor of the mobile apparatus at a second time of a respective second radio node identified by a respective one of the second radio node identifiers;
obtain a second position estimate for the mobile apparatus, the second position estimate corresponding to a second horizontal position of a second location where the mobile apparatus was located at the second time;
determine that (i) the first horizontal position and the second horizontal position are substantially similar and (ii) there are one or more differences between the first radio data and the second radio data that satisfy one or more threshold criteria; and
based at least in part on the determination that (i) the first horizontal position and the second horizontal position are substantially similar and (ii) there are one or more differences between the first radio data and the second radio data that satisfy one or more threshold criteria, determine that the first location and the second location are located on different floors.
